(19) United States
(12) Patent Application Publication
(10) Pub. No.: US 2018/0356882 A1
(43) Pub. Date: Dec. 13, 2018

(54) HEAD MOUNTED DISPLAY AND CONTROL METHOD FOR HEAD MOUNTED DISPLAY

(71) Applicant: SEIKO EPSON CORPORATION, Tokyo (JP)

(72) Inventors: Hideho KANEKO, Shiojiri-Shi (JP); Masahide TAKANO, Matsumoto-shi (JP)

(73) Assignee: SEIKO EPSON CORPORATION, Tokyo (JP)

(21) Appl. No.: 15/993,960

(22) Filed: May 31, 2018

(30) Foreign Application Priority Data
Jun. 13, 2017 (JP) 2017-115809

(51) Int. Cl. G06F 3/01

(52) U.S. Cl. CPC G06F 3/012

(57) ABSTRACT

An HMD mounted on the head of a user, includes an image display section that displays an image, a processing unit that performs processes including processing on data, a storage unit that stores the data processed by the processing unit, a detection unit that detects that a position of the HMD is not a set position, and a control unit that restricts processing on data correlated with the set position among pieces of the data stored in the storage unit in a case where the detection unit detects that a position of the head mounted display is not the set position.

### BACKGROUND

### 1. Technical Field

The present invention relates to a head mounted display, and a control method for the head mounted display.

### 2. Related Art

In the related art, there is a technique of changing a function of a head mounted display (HMD) according to a location of the head mounted display (for example, refer to JP-A-2016-40865). According to JP-A-2016-40865, in a case where it is detected that a head mounted display has been moved to a specific location, a predetermined function installed in the head mounted display is changed.

One of advantages of a head mounted display may be a light feeling in use since the head mounted display is mounted on a user's body. As disclosed in JP-A-2016-40865, an application of displaying an image or the like in a situation in which a user is moving is one of principal applications of a head mounted display. In this use state, there is a probability that the head mounted display may be used at a location far from a location expected as a usage location of the head mounted display due to the user's intention or carelessness. There is also a probability that the head mounted display may be carried away from a location expected as a usage location.

### SUMMARY

An advantage of some aspects of the invention is to suppress usage in a state of being separated from a location expected as a usage location or carrying-away therefrom with respect to a head mounted display.

An aspect of the invention is directed to a head mounted display mounted on the head of a user, and including a display unit that displays an image; a processing unit that performs processes including processing on data; a storage unit that stores the data processed by the processing unit; a detection unit that detects that a position of the head mounted display is not a set position; and a control unit that restricts processing on data correlated with the set position among pieces of the data stored in the storage unit in a case where the detection unit that a position of the head mounted display is not the set position.

According to the aspect of the invention, in a case where the head mounted display is moved from a set position to another position, it is possible to restrict processing on data in the head mounted display. Thus, it is possible to achieve a suppression effect with respect to movement of the head mounted display to an unexpected location. Therefore, whether or not the head mounted display is available can be controlled in relation to a location of use, and, thus, for example, it is possible to expect an effect of suppressing carrying-away of the head mounted display or the illegal use of data.

The configuration described above may be configured such that the head mounted display further includes an external scenery imaging unit that images external scenery, and the detection unit detects that a position of the head mounted display is not the set position on the basis of at least one of a captured image obtained by the external scenery imaging unit and security information correlated with the set position.

According to this configuration, it is possible to control the use of the head mounted display by using a captured image of external scenery which is an external real space of the head mounted display, or security information correlated with a location.

The configuration described above may be configured such that the detection unit detects that a position of the head mounted display is not the set position on the basis of the captured image obtained by the external scenery imaging unit and the security information correlated with the set position.

According to this configuration, it is possible to control the use of the head mounted display by using a captured image of external scenery which is an external real space of the head mounted display, or security information correlated with a location.

The configuration described above may be configured such that the storage unit stores the data including an application program, the processing unit executes the application program so as to execute a function of the head mounted display, and the control unit restricts execution of the application program correlated with the set position.

According to this configuration, it is possible to control execution of the application program for realizing the functions of the head mounted display on the basis of a position of the head mounted display. Consequently, it is possible to appropriately control the use of the head mounted display having various functions. The functions of the head mounted display can be finely controlled, for example, by limiting a restriction target application program in order to restrict execution in the unit of the application program.

The configuration described above may be configured such that the control unit causes the detection unit to perform detection when the head mounted display is activated in a stoppage state or a power-off state, and, in a case where the detection unit detects that a position of the head mounted display is not the set position, the control unit restricts access to the data which is stored in the storage unit and is correlated with the set position.

According to this configuration, it is possible to restrict the use of the head mounted display at an inappropriate location, for example, in a case where the head mounted display is moved from a set location while the head mounted display is in a stoppage state or a power-off state. Thus, it is possible to expect an effect of further suppressing movement of the head mounted display to an unexpected location.

The configuration described above may be configured such that, in a case where the detection unit detects that a position of the head mounted display is not the set position when the head mounted display is activated in a stoppage state or a power-off state, the control unit erases the data which is stored in the storage unit and is correlated with the set position.

According to this configuration, it is possible to restrict the use of data of the head mounted display, for example, in a case where the head mounted display is moved from a set location while the head mounted display is in a stoppage state or a power-off state. Thus, it is possible to reliably restrict the use of data at an unexpected location and thus to expect an effect of preventing the improper use of data.

The configuration described above may be configured such that the detection unit detects that a use state of the head mounted display is not a set use state, and, in a case where the detection unit detects that a use state of the head mounted display is not the set use state, the control unit restricts processing on data correlated with the set position among the pieces of data stored in the storage unit.

According to this configuration, the use of data is restricted on the basis of a use state of the head mounted display. Thus, it is possible to expect an effect of preventing the improper use of the data.

Another aspect of the invention is directed to a control method for a head mounted display including a display unit that displays an image, a processing unit that performs processes including processing on data, and a storage unit that stores the data processed by the processing unit, the control method including restricting processing on data correlated with a set position among pieces of the data stored in the storage unit in a case where it is detected that a position of the head mounted display is not the set position.

According to the aspect of the invention, in a case where the head mounted display is moved from a set position to another position, it is possible to restrict processing on data in the head mounted display. Thus, it is possible to achieve a restriction effect with respect to movement of the head mounted display to an unexpected location. Therefore, whether or not the head mounted display is available can be controlled in relation to a location of use, and, thus, for example, it is possible to expect an effect of suppressing carrying-away of the head mounted display or the illegal use of data.

The invention may be realized in various aspects other than the head mounted display and the control method for the head mounted display. For example, the invention may be realized in aspects such as a program causing a computer to execute the control method, a recording medium recording the program thereon, a server apparatus which distributes the program, a transmission medium which transmits the program, and data signals in which the program is embodied in carrier waves.

### BRIEF DESCRIPTION OF THE DRAWINGS

The invention will be described with reference to the accompanying drawings, wherein like numbers reference like elements.

FIG. 1 is a diagram illustrating a schematic configuration of an HMD in an embodiment.

FIG. 2 is a block diagram illustrating a functional configuration of the HMD.

FIG. 3 is a diagram illustrating a state in which image light is emitted by an image light generation unit.

FIG. 4 is a diagram illustrating a platform of the HMD.

FIG. 5 is a schematic diagram illustrating information stored in a storage unit.

FIG. 6 is a flowchart illustrating an operation of the HMD.

FIG. 7 is a flowchart illustrating an operation of the HMD.

FIG. 8 is a diagram illustrating a form of usage of the HMD in an art museum.

FIG. 9 is a flowchart illustrating a route guidance process routine.

FIG. 10 is a flowchart illustrating details of an exhibit explanation routine.

FIG. 11 is a diagram illustrating an example of a usage location of the HMD in Application Example 3.

FIG. 12 is a diagram illustrating an example of a display aspect of the HMD in Application Example 3.

FIG. 13 is a diagram illustrating an example of a display aspect of the HMD in Application Example 6.

### DESCRIPTION OF EXEMPLARY EMBODIMENTS

### A. Embodiment

### A-1. Configuration of Head Mounted Display

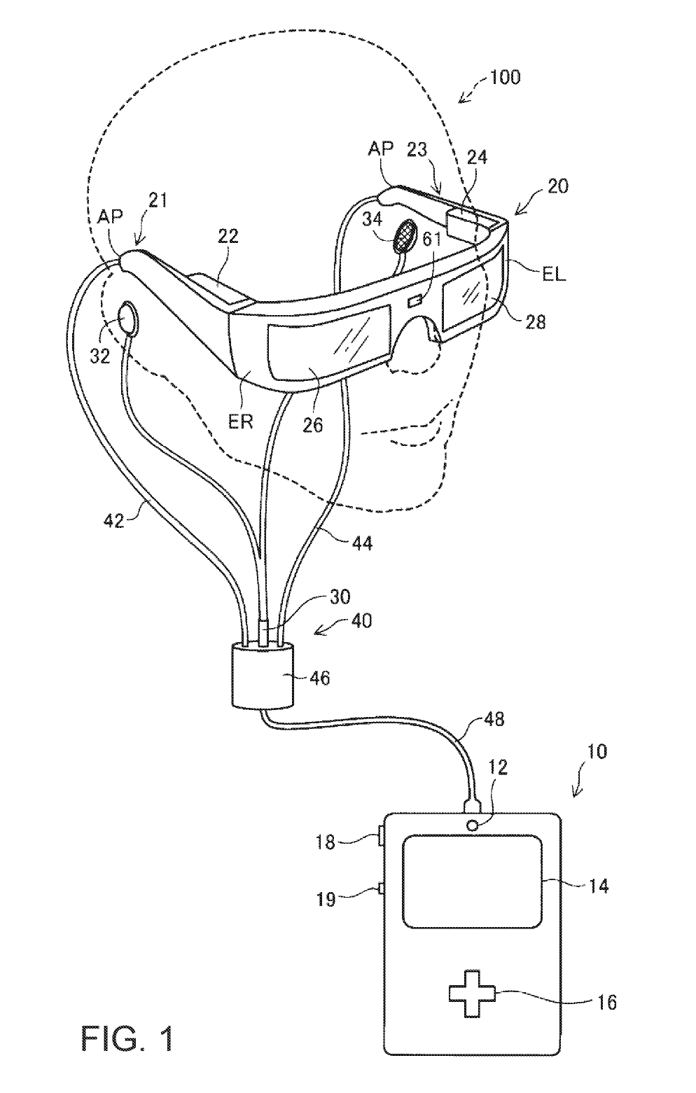

FIG. 1 is a diagram illustrating a schematic configuration of a head mounted display (hereinafter, referred to as an HMD) in an embodiment to which the invention is applied. An HMD 100 is a display which is mounted and used on the head of a user, and is an optically transmissive display which enables a user to visually recognize a virtual image and also to directly visually recognize external scenery.

The HMD 100 includes an image display section 20 (display section) which enables a user to visually recognize a virtual image in a state of being mounted on the head of the user, and a control section (controller) 10 which controls the image display section 20.

The image display section 20 is a mounting body which is mounted on the head of the user, and has a spectacle shape in the present embodiment. The image display section 20 includes a right holding unit 21, a right display drive unit 22, a left holding unit 23, a left display drive unit 24, a right optical image display unit 26, and a left optical image display unit 28. The right optical image display unit 26 and the left optical image display unit 28 are respectively disposed to be located in front of the right and left eyes of the user when the user wears the image display section 20. One end of the right optical image display unit 26 and one end of the left optical image display unit 28 are connected to each other at the position corresponding to the glabella of the user when the user wears the image display section 20.

The right holding unit 21 is a member which is provided so as to extend over a position corresponding to the temporal region of the user from an end part ER which is the other end of the right optical image display unit 26 when the user wears the image display section 20. Similarly, the left holding unit 23 is a member which is provided so as to extend over a position corresponding to the temporal region of the user from an end part EL which is the other end of the left optical image display unit 28 when the user wears the image display section 20. The right holding unit 21 and the left holding unit 23 hold the image display section 20 on the head in the same manner as temples of spectacles.

The right display drive unit 22 is disposed inside the right holding unit 21, that is, on a side opposing the head of the user when the user wears the image display section 20.

The left display drive unit 24 is disposed inside the left holding unit 23. Hereinafter, the right holding unit 21 and the left holding unit 23 are collectively simply referred to as “holding units”. Similarly, the right display drive unit 22 and the left display drive unit 24 are collectively simply referred to as “display drive units”, and the right optical image display unit 26 and the left optical image display unit 28 are collectively simply referred to as “optical image display units”.

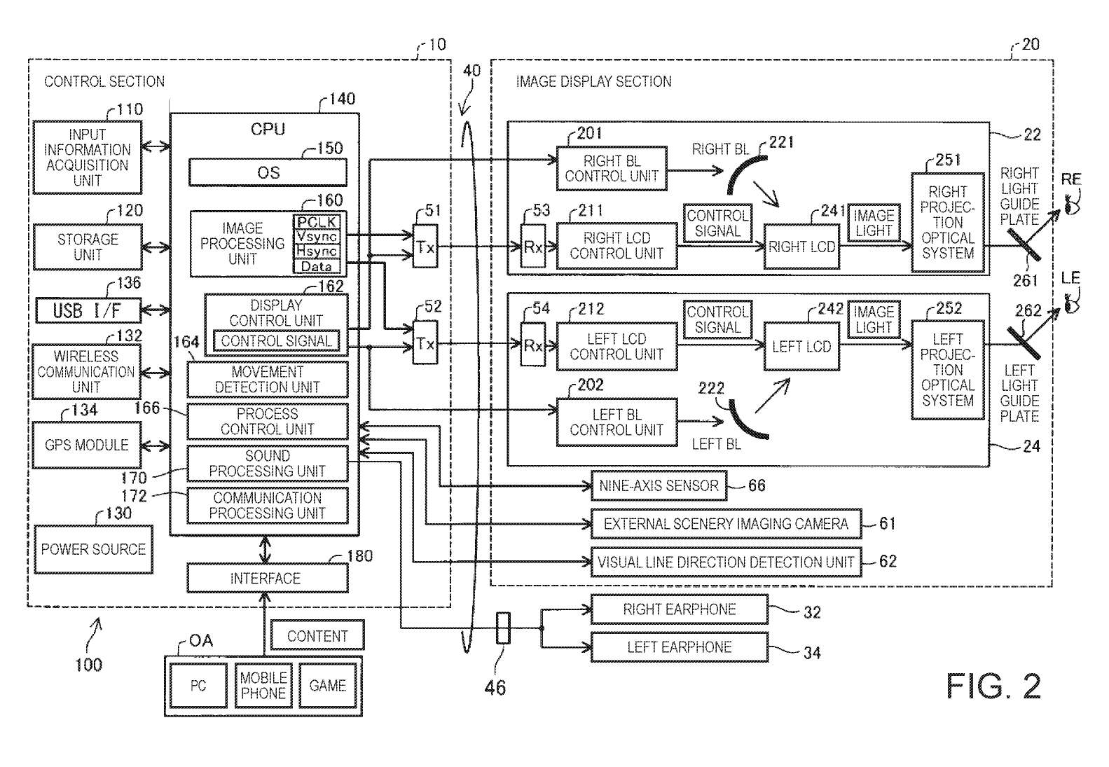

The display drive units respectively include liquid crystal displays (hereinafter, referred to as “LCDs”) 241 and 242, projection optical systems 251 and 252, and the like (refer to FIG. 2). Details of configurations of the display drive units will be described later. The optical image display units as optical members include light guide plates 261 and 262 (refer to FIG. 2) and dimming plates. The light guide plates 261 and 262 are made of light transmissive resin material or the like and guide image light which is output from the display drive units 22 and 24 to the eyes of the user. The dimming plate is a thin plate-shaped optical element, and is disposed to cover a surface side of the image display section 20 (an opposite side to the user's eye side). The dimming plate protects the light guide plates 261 and 262 so as to prevent the light guide plates 261 and 262 from being damaged, polluted, or the like. An amount of external light entering the eyes of the user is adjusted by adjusting light transmittance of the dimming plates, and thus it is possible to control an extent of visually recognizing a virtual image. The dimming plate may be omitted.

The image display section 20 is configured to include the right LCD 241 and the left LCD 242 as one specific example, but may employ other display types. For example, organic electroluminescence (EL) elements may be used. In this case, an organic EL display is disposed instead of the right LCD 241, a right backlight 221, the left LCD 242, and a left backlight 222. Here, the organic EL element may be an organic light emitting diode (OLED).

The image display section 20 further includes a connection unit 40 which connects the image display section 20 to the control section 10. The connection unit 40 includes a main body cord 48 connected to the control section 10, a right cord 42 and a left cord 44 which are two cords into which the main body cord 48 branches out, and a connection member 46 provided at the branch point. The connection member 46 is provided with a jack for connection of an earphone plug 30. A right earphone 32 and a left earphone 34 extend from the earphone plug 30.

The image display section 20 and the control section 10 transmit various signals via the connection unit 40. An end part of the main body cord 48 on an opposite side to the connection member 46, and the control section 10 are respectively provided with connectors (not illustrated) fitted to each other. The connector of the main body cord 48 and the connector of the control section 10 are fitted into or released from each other, and thus the control section 10 is connected to or disconnected from the image display section 20. For example, a metal cable or an optical fiber may be used as the right cord 42, the left cord 44, and the main body cord 48.

The control section 10 is a device used to control the HMD 100. The control section 10 includes a lighting unit 12, a touch pad 14, a cross key 16, and a power switch 18. The lighting unit 12 indicates an operation state (for example, ON/OFF of a power source) of the HMD 100 by using a light emitting aspect thereof. For example, an LED may be used as the lighting unit 12. The touch pad 14 detects an operation on an operation surface of the touch pad 14 so as to output a signal based on detected content. Various touch pads of a capacitance type, a pressure detection type, and an optical type may be employed as the touch pad 14. The cross key 16 detects a pushing operation on keys corresponding to vertical and horizontal directions so as to output a signal based on detected content. The power switch 18 detects a sliding operation of the switch so as to change a power source state of the HMD 100.

FIG. 2 is a functional block diagram illustrating a configuration of the HMD 100. The control section 10 includes an input information acquisition unit 110, a storage unit 120, a power source 130, a wireless communication unit 132, a GPS module 134, a USB interface 136, a CPU 140, an interface 180, and transmission units (Tx) 51 and 52. The respective units are connected to each other via a bus (not illustrated).

The input information acquisition unit 110 acquires a signal corresponding to an input operation on, for example, the touch pad 14, the cross key 16, or the power switch 18. The storage unit 120 is formed of a semiconductor storage element or a hard disk device, and stores a program executed by the CPU 140 or data processed by the CPU 140 in a nonvolatile manner. The storage unit 120 may include a transitory storage device which transitorily stores a program or data according to an operation of the CPU 140, and may include, for example, a RAM or a DRAM.

The power source 130 supplies power to the respective units of the HMD 100. For example, a secondary battery such as a lithium polymer battery or a lithium ion battery may be used as the power source 130. Instead of a secondary battery, a primary battery or a fuel battery may be used, and the HMD 100 may be operated through wireless power supply. The HMD 100 may receive the supply of power from a solar battery and a capacitor.

The wireless communication unit 132 performs wireless communication with other apparatuses on the basis of a predetermined wireless communication standard such as a wireless LAN (including WiFi (registered trademark)), Bluetooth (registered trademark), or iBeacon (registered trademark). Here, the wireless communication unit 132 may perform communication based on the Bluetooth Low Energy (BLE) standard with a Bluetooth smart device. The wireless communication unit 132 may be configured to perform near field communication (NFC). The GPS module 134 measures the current position thereof by receiving a signal from a GPS satellite. The GPS module 134 may perform positioning using a signal transmitted from a positioning system (for example, GLONASS) using a satellite other than a GPS satellite, or a satellite (for example, quasi-zenith satellite Michibiki) complementing a GPS. The GPS module 134 may acquire data (for example, A-GPS) from a server apparatus which can perform communication with the wireless communication unit 132, and may perform positioning using the acquired data.

The CPU 140 (processing unit) functions as an operating system (OS) 150, an image processing unit 160, a display control unit 162, a movement detection unit 164, a process control unit 166, a sound processing unit 170, and a communication processing unit 172. The CPU 140 reads and executes computer programs stored in the storage unit 120, so as to function as each of the above-described units.

The image processing unit 160 generates a signal on the basis of the content (video) which is input via the interface 180 or the wireless communication unit 132. The image processing unit 160 supplies the generated signal to the image display section 20 via the connection unit 40, so as to control the image display section 20. The signal to be supplied to the image display section 20 has a difference between an analog type and a digital type. In a case of the analog type, the image processing unit 160 generates and transmits a clock signal PCLK, a vertical synchronization signal VSync, a horizontal synchronization signal HSync, and image data Data.

Specifically, the image processing unit 160 acquires an image signal included in the content. For example, in a case of a moving image, the acquired image signal is generally an analog signal including 30 frame images per second. The image processing unit 160 separates a synchronization signal such as the vertical synchronization signal VSync or the horizontal synchronization signal HSync from the acquired image signal, and generates the clock signal PCLK through the use of a PLL circuit or the like on the basis of the period of the synchronization signal. The image processing unit 160 converts the analog image signal from which the synchronization signal is separated into a digital image signal by the use of an A/D conversion circuit or the like. The image processing unit 160 stores the converted digital image signal as the image data Data of RGB data in the DRAM of the storage unit 120 for each frame.

On the other hand, in the case of the digital type, the image processing unit 160 generates and transmits the clock signal PCLK and the image data Data. Specifically, in a case where the content is of a digital type, the clock signal PCLK is output in synchronization with the image signal and thus the generation of the vertical synchronization signal VSync and the horizontal synchronization signal HSync and the A/D conversion of the analog image signal are not necessary. The image processing unit 160 may perform various color correcting processes such as a resolution converting process and adjustment of luminance and chroma and image processing such as a keystone correcting process on the image data Data stored in the storage unit 120.

The image processing unit 160 transmits the generated clock signal PCLK, vertical synchronization signal VSync, and horizontal synchronization signal HSync and the image data Data stored in the DRAM of the storage unit 120 via the transmission units 51 and 52. The image data Data transmitted via the transmission unit 51 is also referred to as “right-eye image data Data1” and the image data Data transmitted via the transmission unit 52 is also referred to as “left-eye image data Data2”. The transmission units 51 and 52 function as transceivers for serial transmission between the control section 10 and the image display section 20.

The display control unit 162 generates a control signal for controlling the right display drive unit 22 and the left display drive unit 24. Specifically, the display control unit 162 individually controls drive ON/OFF of the right LCD 241 by using a right LCD control unit 211, and drive ON/OFF of the right backlight 221 by using a right backlight control unit 201 on the basis of a control signal. The display control unit 162 individually controls drive ON/OFF of the left LCD 242 by using a left LCD control unit 212, and drive ON/OFF of the left backlight 222 by using a left backlight control unit 202 on the basis of the control signal. Through such control, the display control unit 162 controls generation and emission of image light from the right display drive unit 22 and the left display drive unit 24. The display control unit 162 transmits the control signals for the right LCD control unit 211 and the left LCD control unit 212 via the transmission units 51 and 52, respectively. Similarly, the display control unit 162 transmits the control signals for the right backlight control unit 201 and the left backlight control unit 202, respectively.

The movement detection unit 164 (detection unit) detects that the HMD 100 mounted on the head of the user has been moved to a plurality of specific locations set in advance. Specifically, the movement detection unit 164 determines whether or not a position of the HMD 100 is a preset position or is within a preset range. Details of a process in which the movement detection unit 164 detects or acquires a position of the HMD 100 will be described later.

The process control unit 166 (control unit) changes at least some predetermined functions of various functions of the HMD 100 on the basis of a detection result in the movement detection unit 164. A predetermined function may be a single function or a plurality of functions, and is a plurality of functions in the present embodiment. Details of the movement detection unit 164 and the process control unit 166 will be described later.

The sound processing unit 170 acquires a sound signal included in the content, amplifies the acquired sound signal, and supplies the amplified sound signal to a speaker (not illustrated) in the right earphone 32 connected to the connection member 46 and a speaker (not illustrated) in the left earphone 34 connected to the connection member 46. For example, in a case where a Dolby (registered trademark) system is employed, the sound signal is processed and different sounds having, for example, changed frequencies are output from the right earphone 32 and the left earphone 34.

The communication processing unit 172 controls wireless communication using the wireless communication unit 132 and communication using the USB interface 136. The communication processing unit 172 receives a signal from a BLE terminal (for example, a BLE terminal 670 which will be described later) provided outside the HMD 100 by using the technique of iBeacon (registered trademark) or other well-known Bluetooth signal techniques. The communication processing unit 172 performs communication based on a wireless LAN standard. The communication processing unit 172 may obtain a distance between a communication partner apparatus such as a BLE terminal and the HMD 100 on the basis of a reception signal intensity of a received signal.

The interface 180 is an interface for connecting various external apparatuses OA as a source of content to the control section 10. Examples of the external apparatus OA include a personal computer PC, a mobile terminal, and a game terminal. For example, a USB interface, a micro USB interface, and a memory-card interface may be used as the interface 180.

The image display section 20 includes the right display drive unit 22, the left display drive unit 24, a right light guide plate 261 as the right optical image display unit 26, a left light guide plate 262 as the left optical image display unit 28, an external scenery imaging camera 61 (refer to FIG. 1), and a nine-axis sensor 66.

The external scenery imaging camera 61 (external scenery imaging unit) is disposed at a position between the user's eyebrows when the user wears the image display section 20. Thus, the external scenery imaging camera 61 images external scenery in a direction in which the user is directed in a state where the user mounts the image display section 20 on the head thereof. The external scenery imaging camera 61 is a monocular camera, but may be a stereoscopic camera.

The nine-axis sensor 66 is a motion sensor that measures accelerations (in three axes), angular velocities (in three axes), and terrestrial magnetism (in three axes). The nine-axis sensor 66 is disposed in the image display section 20, and thus detects movement of the user's head when the image display section 20 is mounted on the user's head. A direction of the image display section 20 is specified on the basis of the detected movement of the user's head.

The right display drive unit 22 includes a reception unit (Rx) 53, the right backlight (BL) control unit 201 and the right backlight (BL) 221 serving as a light source, the right LCD control unit 211 and the right LCD 241 serving as a display element, and a right projection optical system 251. The right backlight control unit 201, the right LCD control unit 211, the right backlight 221, and the right LCD 241 are also collectively referred to as an “image light generation unit”.

The reception unit 53 functions as a receiver for serial transmission between the control section 10 and the image display section 20. The right backlight control unit 201 drives the right backlight 221 on the basis of an input control signal. The right backlight 221 is a light emitting member such as an LED or an electroluminescence (EL). The right LCD control unit 211 drives the right LCD 241 on the basis of the clock signal PCLK, the vertical synchronization signal VSync, the horizontal synchronization signal HSync, and the right-eye image data Data1 which are input via the reception unit 53. The right LCD 241 is a transmissive liquid crystal panel in which a plurality of pixels are arranged in a matrix form.

The right projection optical system 251 includes a collimator lens which changes the image light emitted from the right LCD 241 to a parallel light beam. The right light guide plate 261 as the right optical image display unit 26 guides the image light output from the right projection optical system 251 to the user's right eye RE while reflecting the image light along a predetermined optical path. The optical image display unit may employ any method as long as it can form a virtual image in front of the user's eyes using image light. For example, a diffraction grating or a semi-transmissive film may be used. The HMD 100 emitting image light is also referred to as “displaying an image”.

The left display drive unit 24 has the same configuration as the right display drive unit 22. That is, the left display drive unit 24 includes a reception unit (Rx) 54, the left backlight (BL) control unit 202 and the left backlight (BL) 222 serving as a light source. The left display drive unit 24 includes the left LCD control unit 212 and the left LCD 242 serving as a display element, and a left projection optical system 252.

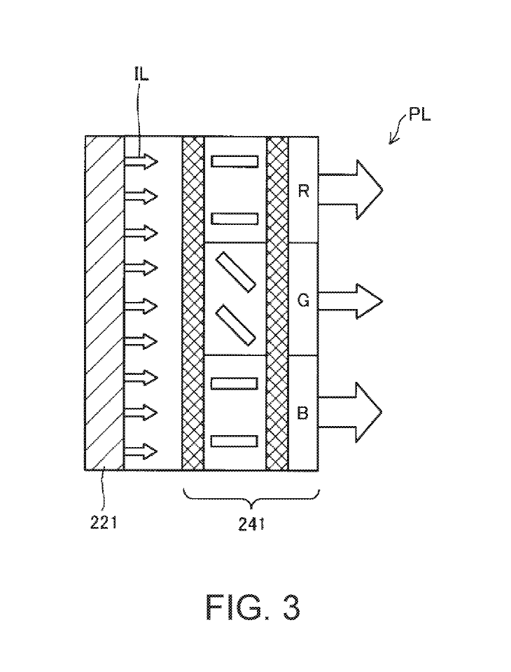

FIG. 3 is a diagram illustrating a state in which image light is emitted from the image light generation unit. The right LCD 241 changes the transmittance of light transmitted through the right LCD 241 by driving liquid crystal at a position of each of the pixels arranged in a matrix form, and thus modulates illumination light IL applied from the right backlight 221 into valid image light PL indicating an image. This is also the same for the left side. As illustrated in FIG. 3, a backlight type is employed in the present embodiment, but a configuration of emitting image light by using a front light type or a reflection type may be used.

### A-2. Platform of Head Mounted Display

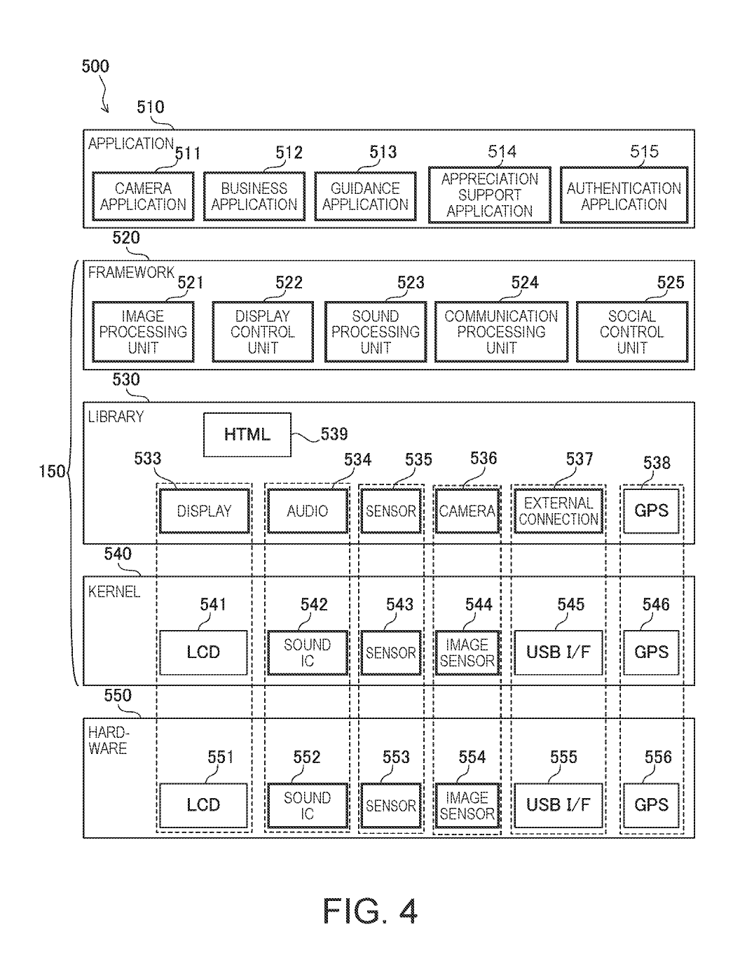

FIG. 4 is a diagram illustrating a platform of the HMD 100. The platform is an aggregation of hardware resources, an OS, and middleware, which are bases required to operate an application installed in the HMD 100. A platform 500 of the present embodiment includes an application layer 510, a framework layer 520, a library layer 530, a kernel layer 540, and a hardware layer 550. The respective layers 510 to 550 are obtained by conceptually dividing hardware resources, an OS, and middleware included in the platform 500 into layers. A function of an OS 150 (FIG. 2) is realized by the framework layer 520, the library layer 530, and the kernel layer 540. In FIG. 4, a constituent element which is not necessary for description is not illustrated.

The application layer 510 is an aggregation of application software for performing a predetermined process on the OS 150. Each application software included in the application layer 510 will be referred to as an “application”. The application layer 510 includes both of an application installed in the HMD 100 in advance and an application installed in the HMD 100 by the user.

In the example illustrated in FIG. 4, the application layer 510 includes a camera application 511, a business application 512, a guidance application 513, an appreciation support application 514, and an authentication application 515. The camera application 511 provides an imaging function. The business application 512 provides functions of applications such as a document creation application program, a table computation application program, a presentation program, and a web browser. The business application 512 may provide functions of a map display application program, and an application program for creating, editing, and transmitting and receiving mails. The guidance application 513 provides a guide function suitable for tour and/or guidance of an art museum, a museum, and an amusement facility. The appreciation support application 514 provides a function of providing information during watching of performances in a theater, a movie theater, or the like. The authentication application 515 provides a function for authenticating the HMD 100 in an external apparatus.

The framework layer 520 is an aggregation of programs installed with fundamental program structures or function sets common to the application software of the application layer 510. In the present embodiment, the framework layer 520 includes an image processing unit frame 521, a display control unit frame 522, a sound processing unit frame 523, a communication processing unit frame 524, a social control unit frame 525, and the like. The image processing unit frame 521 realizes a function of the image processing unit 160 (FIG. 2). The display control unit frame 522 realizes a function of the display control unit 162 (FIG. 2). The sound processing unit frame 523 realizes a function of the sound processing unit 170 (FIG. 2). The communication processing unit frame 524 realizes a function of the communication processing unit 172 (FIG. 2). The social control unit frame 525 realizes functions of the movement detection unit 164 and the process control unit 166.

The library layer 530 is an aggregation of pieces of component library software which allows a program for realizing a specific function to be used from other programs (for example, the applications included in the application layer 510). Each piece of library software included in the library layer 530 will be hereinafter referred to as a “library”. The library cannot be executed alone, and is executed in a form of being called by another program.

In the example illustrated in FIG. 4, the library layer 530 includes a display library 533, an audio library 534, a sensor library 535, a camera library 536, an external connection library 537, and a GPS library 538. The library layer 530 also includes a Hyper Text Markup Language (HTML) library 539. The library layer 530 may include other libraries.

The display library 533 drives the right LCD 241 and the left LCD 242 (FIG. 2). The audio library 534 drives sound integrated circuits (ICs) built into the right earphone 32 and the left earphone 34 (FIG. 2). The sensor library 535 drives the nine-axis sensor 66 (FIG. 2), and also acquires a measured value in the nine-axis sensor 66 and processes the measured value into information to be provided to an application. The camera library 536 drives the external scenery imaging camera 61 (FIG. 2), and also acquires a measured value in the external scenery imaging camera 61 and generates an external scenery image by using the measured value. The external connection library 537 controls the USB interface 136 so as to acquire data received by the USB interface 136, and to transmit data via the USB interface 136. The GPS library 538 controls the GPS module 134 so as to measure a position, and acquires position information indicating the measured position. The HTML library 539 interprets data described in a webpage description language, and computes arrangement of screen display text or images.

The kernel layer 540 is an aggregation of programs installed with fundamental functions of the OS 150. The kernel layer 540 has a function of managing exchange between software (library layer 530) and hardware (hardware layer 550), and causing both of the two to cooperate with each other. In other words, the platform 500 causes the hardware and the software to cooperate with each other through the function of the kernel layer 540, and realizes the functions of the HMD 100.

In the example illustrated in FIG. 4, the kernel layer 540 includes an LCD driver 541 for driving the right LCD 241 and the left LCD 242. The kernel layer 540 includes a sound IC driver 542 for driving the sound ICs, a sensor driver 543 for driving the nine-axis sensor 66, and an image sensor driver 544 for driving an image sensor built into the external scenery imaging camera 61. The kernel layer 540 includes an USB interface driver 545 for driving the USB interface 136 and a GPS driver 546 for the GPS module 134.

The hardware layer 550 is an actual hardware resource incorporated into the HMD 100. In the present embodiment, the “hardware resource” indicates a device connected to the HMD 100 or incorporated into the HMD 100.

In other words, the hardware resource includes a device internally connected to a mainboard of the HMD 100. Such a device may include, for example, a sensor device of the nine-axis sensor 66, an image sensor device of the external scenery imaging camera 61, a sensor device of the touch pad 14, the USB interface 136, and the GPS module 134. The hardware resource includes a device externally connected to the HMD 100 via the interface 180. Such a device may include, for example, an externally attached motion sensor device and an externally attached USB device.

In the example illustrated in FIG. 4, the hardware layer 550 includes an LCD device 551 as the right LCD 241 and the left LCD 242, a sound IC device 552, a sensor device 553 of the nine-axis sensor 66, and an image sensor device 554 of the external scenery imaging camera 61. The hardware layer 550 includes a USB interface 555 corresponding to the USB interface 136, and a GPS device 556 in the GPS module 134.

The library, the driver, and the device surrounded by a dashed line in FIG. 4 have a correspondence relationship, and are operated in cooperation with each other. For example, the sensor library 535, the sensor driver 543, and the sensor device 553 are operated in cooperation with each other in order to realize the function of the nine-axis sensor 66. In other words, the sensor library 535 of the library layer 530 and the sensor driver 543 of the kernel layer 540 are programs which allow the applications included in the application layer 510 to use the sensor device 553 as a hardware resource. The hardware resource indicates a device included in the hardware layer 550 as described above. In a description of the present embodiment, the program is an expression having the same meaning as software or indicating similarity thereto. There may be a configuration in which a plurality of libraries are allocated to the sensor device 553 such that the sensor device 553 as a single hardware resource is available.

For example, the hardware layer 550 may include other devices in addition to the respective devices illustrated in FIG. 4. The kernel layer 540 may include a program corresponding to each device included in the hardware layer 550.

On the other hand, in FIG. 4, for example, the HTML library 539 of the library layer 530 has no correspondence relationship with a hardware resource, and does not depend on a hardware resource. As mentioned above, a program (software) which is incorporated into the HMD 100 and does not depend on a hardware resource is referred to as a “software resource” in the present embodiment. As the software resource, there may be various programs included in the respective layers such as the framework layer 520, the library layer 530, and the kernel layer 540.

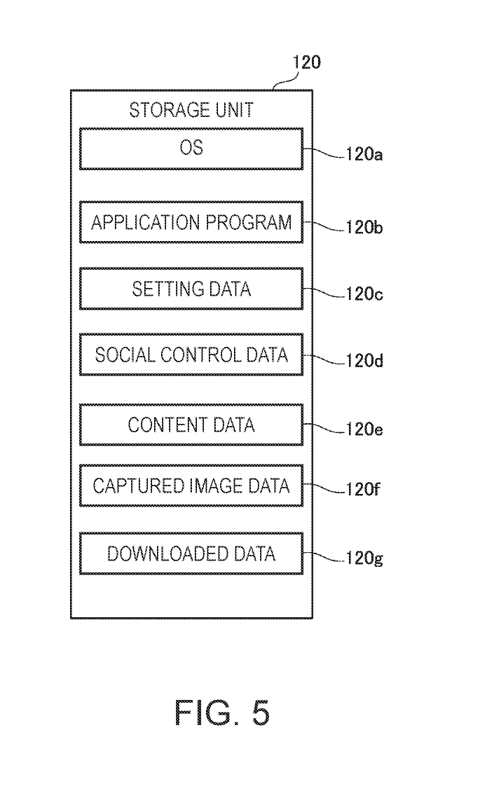

FIG. 5 is a schematic diagram illustrating information stored in the storage unit 120.

The storage unit 120 stores an OS 120a executed by the CPU 140, an application program 120b, setting data 120c, social control data 120d, and content data 120e. The storage unit 120 stores captured image data 120f obtained by the external scenery imaging camera 61, and downloaded data 120g which is acquired and downloaded via the wireless communication unit 132 or the USB interface 136.

The OS 120a is loaded and executed by the CPU 140, and forms the OS 150 (FIG. 2). The application program 120b is executed by the CPU 140, and forms each application of the application layer 510 (FIG. 4). The setting data 120c includes data indicating the setting content regarding an operation of the HMD 100.

The social control data 120d includes data regarding setting of a function restriction on the HMD 100 based on a position of the HMD 100. The social control data 120d includes setting data regarding an application, a framework, a library, a kernel, and the like of which execution is restricted on the basis of a position of the HMD 100. The social control data 120d may include data designating data to which access is restricted or which is a deletion target on the basis of a position of the HMD 100. The social control data 120d includes setting data regarding a position of the HMD 100 in a case where a function restriction on the HMD 100 is performed. The social control data 120d may include data such as a GPS coordinate for specifying a position or a range of a position at which the functions of the HMD 100 can be used (an available position or an available range).

The content data 120e is data of the content reproduced when the business application 512, the guidance application 513, and the appreciation support application 514 are executed, and includes sound data, video data, still image data, and the like.

### A-3. Function Restriction on Head Mounted Display

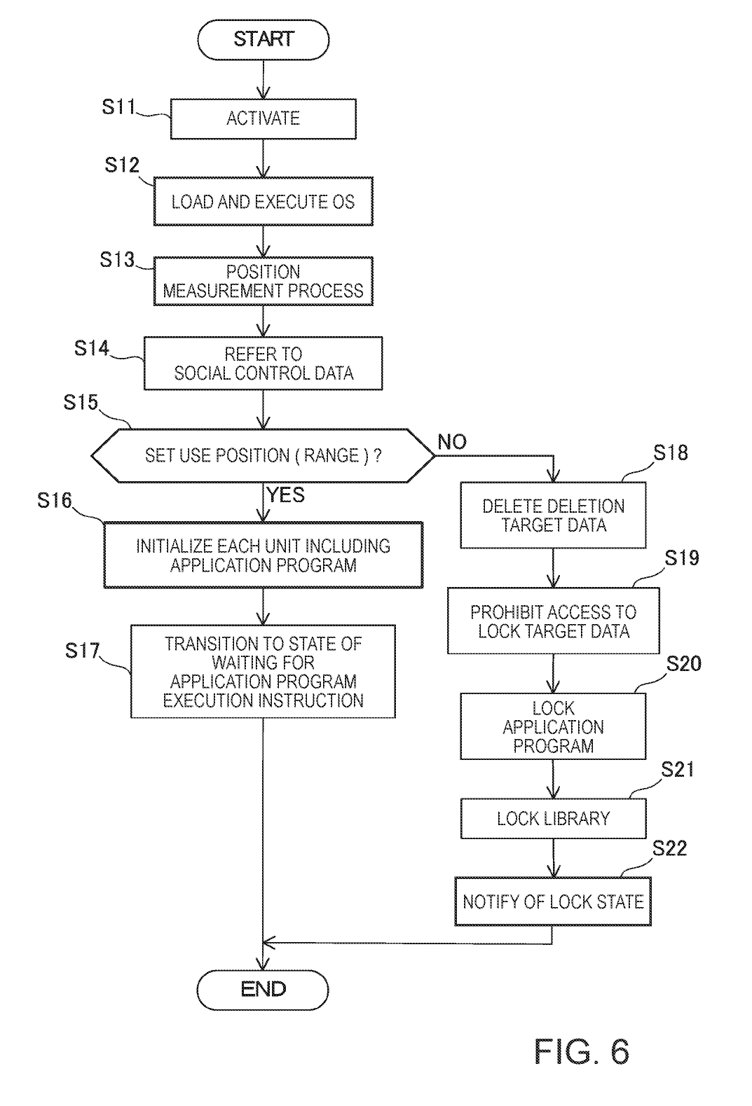

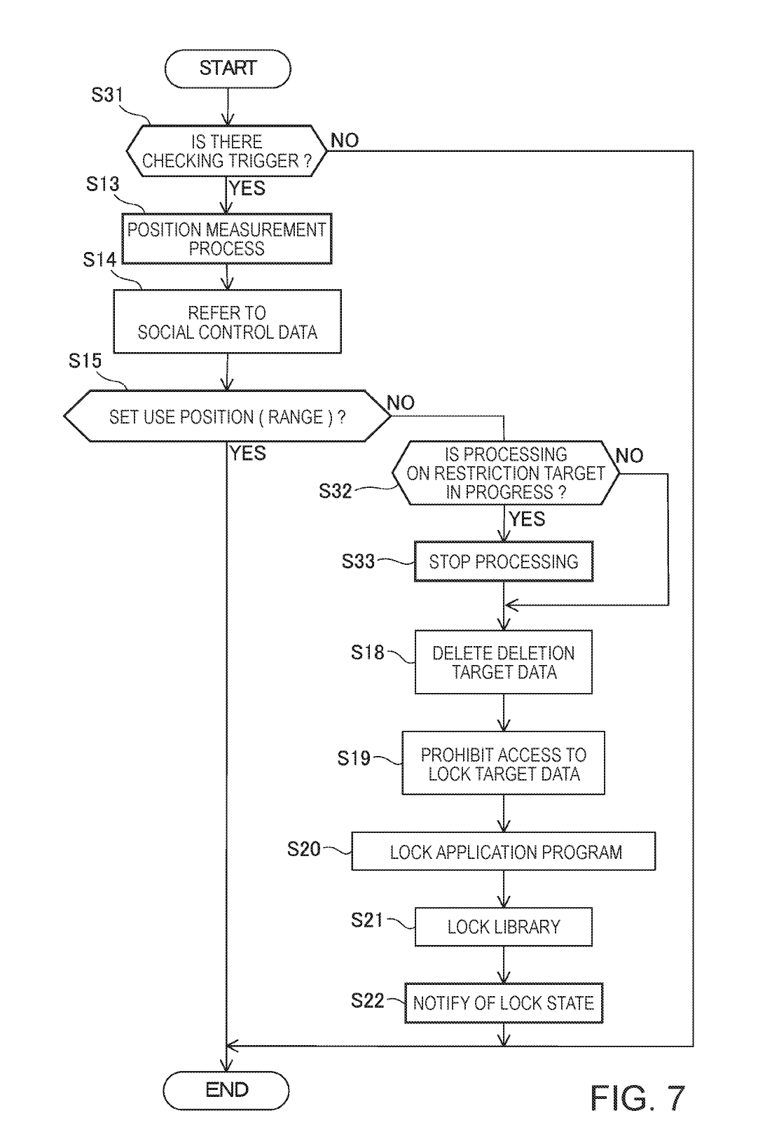

FIGS. 6 and 7 are flowcharts illustrating an operation of the HMD 100. FIG. 6 illustrates an operation regarding a function restriction on the HMD 100 during activation, and FIG. 7 illustrates an operation regarding a function restriction on the HMD 100 during operation of the HMD 100.

In a case where the power source switches to an ON state in a state in which the HMD 100 is in a stoppage state (including a so-called sleep state or a suspend state for saving power) or a power-off state, the CPU 140 starts an activation process (step S11).

The CPU 140 loads the OS 120a from the storage unit 120 and executes the OS 120a, so as to configure the function of the OS 150 (step S12).

The CPU 140 performs a position measurement process, so as to acquire a position of the HMD 100 (step S13). The position measurement process is a process corresponding to the function of the movement detection unit 164. The operation in step S13 may be performed according to, for example, three methods (1) to (3) described below.

### (1) Position Measurement Using GPS Module

The CPU 140 controls the GPS module 134 to calculate and acquire the current position of the HMD 100.

### (2) Position Measurement Using Wireless Communication Unit

The CPU 140 receives a beacon signal from an external beacon device (Bluetooth beacon or the like) via the wireless communication unit 132, calculates a distance from the beacon device which is a transmission source, and obtains a position of the HMD 100.

Alternatively, the CPU 140 receives a beacon signal transmitted from a beacon device of which a position is set in advance via the wireless communication unit 132, and obtains a position of the HMD 100 with the position of the beacon device which is a transmission source as a reference.

Alternatively, in a case where the CPU 140 receives a beacon signal transmitted from a beacon device of which a position is set in advance via the wireless communication unit 132, the CPU 140 obtains the position of the beacon device which is a transmission source as a position of the HMD 100.

Alternatively, the CPU 140 may acquire an ID (for example, a network ID such as an SSID) included in a radio signal received via the wireless communication unit 132, may retrieve position information correlated with the acquired ID, and may use the retrieved position information as a position of the HMD 100. In this case, position information indicating an available position or an available range of the HMD 100, and the ID included in the radio signal may be included in the social control data 120d in correlation with each other. As an ID corresponding to an available position, only an ID may be included in the social control data 120d.

### (3) Position Measurement Using External Scenery Imaging Camera

The CPU 140 causes the external scenery imaging camera 61 to perform imaging, and analyzes a captured image.

The HMD 100 causes image data of an image which can be used to specify of a position of the HMD 100 or feature amount data to be included in the social control data 120d, and stores the social control data 120d in the storage unit 120. The image data or the feature amount data is correlated with position information. The CPU 140 compares the image data or the image feature amount data of the social control data 120d with the captured image obtained by the external scenery imaging camera 61, so as to specify position information. According to this process, a surrounding environment of the HMD 100 is imaged by the external scenery imaging camera 61, and a position of the HMD 100 can be specified on the basis of buildings, roads, installation objects, two-dimensional codes, or scenery reflected in a captured image. For example, the functions of the HMD 100 can be used on the basis of a captured image obtained by the external scenery imaging camera 61 imaging a specific two-dimensional code provided in an available position or an available range.

In step S13, the CPU 140 acquires a position of the HMD 100 by performing any one of the processes in the above (1) to (3). The CPU 140 may acquire a position of the HMD 100 by combining a plurality of processes with each other among the processes in the above (1) to (3).

The CPU 140 may acquire a position of the HMD 100 through processes other than the above (1) to (3).

For example, the CPU 140 may combine a plurality of position measurement methods with each other. In other words, a process in which the GPS module 134 measures a position on the basis of a GPS signal may be combined with a process in which the wireless communication unit 132 measures a position on the basis of a radio signal based on a wireless LAN, Bluetooth, or iBeacon. A state of the HMD 100 (boarding a train, a car, an airplane, or the like, located in a room, in the outdoors, in the basement, or the like) may be detected on the basis of acceleration, angular acceleration, geomagnetism, or the like measured by the nine-axis sensor 66, and a result of state detection may be combined with other process results.

The CPU 140 may switch between sensors used for position measurement according to a state (a position, an operation state, an environmental state, or the like) of the HMD 100 or a change in the state. For example, in a case where the HMD 100 is located in an airplane, Bluetooth or iBeacon having the small influence on electronic apparatuses of the airplane may be used without using a radio signal with a frequency of a mobile phone of which the use is restricted due to radio wave interference or a radio signal of wireless LAN.

In this case, the CPU 140 may perform switching in a case where the HMD 100 is moved to the inside of the airplane and in a case where the HMD 100 is moved to the outside of the airplane.

The CPU 140 may change a process according to a social division (a social request corresponding to the social division) of a position of the HMD 100 such as a country, a region, or a public place or a private place where the HMD 100 is located. For example, the CPU 140 may switch between languages or measurement units subjected to processes (including display and sound output) in the HMD 100. For example, a frequency or transmission output of a radio signal transmitted by the wireless communication unit 132 may be adjusted or changed. An imaging resolution of the external scenery imaging camera 61 may be set to a low resolution (for example, 300,000 pixels) in a public place, and may be set to a standard resolution (for example, 12,000,000 pixels) of the external scenery imaging camera 61 in other places.

The CPU 140 refers to the social control data 120d stored in the storage unit 120 (step S14), and determines whether or not the position of the HMD 100 is a position set in the social control data 120d (step S15). A location where the HMD 100 is allowed to be used is set in the social control data 120d in advance as a position or a range of the position. The CPU 140 compares the position of the HMD 100 acquired in step S13 with the position or the range of the position set in advance in the social control data 120d as a location where the HMD 100 is allowed to be used.

In a case where the position of the HMD 100 corresponds to the position set in the social control data 120d or is included in the set range (YES in step S15), the CPU 140 continuously performs the activation process (step S16). In other words, the CPU 140 performs initialization or the like of the function of the OS 150 including the application layer 510, and each piece of hardware of the HMD 100 controlled by the OS 150 (step S16). The CPU 140 transitions to a state of waiting for an instruction for execution of each application of the application layer 510 to be input (step S17), and finishes the present process. In this case, the HMD 100 may execute the camera application 511, the business application 512, the guidance application 513, the appreciation support application 514, and the like through an operation on the touch pad 14.

In a case where the position of the HMD 100 does not correspond to the position set in the social control data 120d and is not included in the set range (NO in step S15), the CPU 140 performs a process of restricting a predetermined functions of the HMD 100.

As described above, the social control data 120d includes data regarding the content of restricting the functions of the HMD 100 in a case where a position of the HMD 100 is not a set position.

In the present embodiment, a restriction on the functions of the HMD 100 includes deletion of data processed by an application, a restriction (lock) of execution of an application, and a restriction (lock) of the use of a library.

Specifically, in a case where data (deletion target data) to be deleted due to a function restriction is set in the social control data 120d, the CPU 140 deletes the deletion target data (step S18). In a case where data (lock target data) to which access is prohibited due to a function restriction is set in the social control data 120d, the CPU 140 prohibits access to the lock target data (step S19). The data to which access is prohibited cannot be read by an application of the application layer 510 or the function of the OS 150 or cannot be edited or copied.

In a case where an application program to be locked is set in the social control data 120d, the CPU 140 locks the lock target application program (step S20). Execution of the locked application cannot be started by the function of the OS 150.

In a case where a library to be locked is set in the social control data 120d, the CPU 140 locks the lock target library (step S21). The locked library cannot be called by the function of the OS 150.

The processes in steps S18 to S21 are performed according to setting information included in the social control data 120d. In a case where deletion target data is not set in the social control data 120d, the process in step S18 is omitted. Similarly, in a case where lock target data is not set in the social control data 120d, the process in step S19 is omitted. In a case where deletion a lock target application is not set, the process in step S20 is omitted. In a case where deletion a lock target library is not set, the process in step S21 is omitted.

In a case where any of the processes in steps S18 to S21 is performed, the CPU 140 performs a notification of the content of the performed process (step S22). Specifically, the content of the performed process, or text or an image indicating deleted or locked data, application or library is displayed on the image display section 20. The CPU 140 may perform a notification using sounds, and may perform a notification of only locking.

Through the operation illustrated in FIG. 6, at the time of activation of the HMD 100, in a case where a position of the HMD 100 is not a position set as a position where the HMD 100 is allowed to be used or is not included in a range thereof, the use of data, an application, a library, and the like can be restricted. Also in a case where the HMD 100 is moved from a set position or range in a standing still state, the use of data, an application, a library, and the like can be restricted when the HMD 100 is activated.

For example, by restricting execution of the business application 512, among the functions of the HMD 100, document creation, table computation, processing of presentation data, web browsing, map display, and creation, editing, and transmission and reception of a mail cannot be performed. Imaging using the external scenery imaging camera 61 cannot be performed due to a restriction on execution of the camera application 511 or a restriction on the camera library 536. Control of an external device cannot be performed due to a restriction on the external connection library 537. A restriction on execution of wireless communication using the wireless communication unit 132 or other applications of the application layer 510 may be performed.

The operation illustrated in FIG. 6 is an operation performed by the CPU 140 functioning as the movement detection unit 164 and the process control unit 166. The operation corresponds to the function of the social control unit frame 525 in FIG. 4. The invention is not limited thereto, and the functions of the HMD 100 may be restricted, for example, by the kernel layer 540 executing the function of the process control unit 166. A function restriction hardware (not illustrated) included in the hardware layer 550 may be mounted in the HMD 100, and, in this case, the function restriction hardware may execute the function of the process control unit 166.

For example, a basic input output system (BIOS) of the HMD 100 or a unified extensible firmware interface (UEFI) mounted instead of the BIOS may execute the function of the process control unit 166 and/or the movement detection unit 164. With this configuration, in a case where the BIOS or the UEFI has a function of locking or unlocking using a password (personal identification number: PIN), a determination result in the movement detection unit 164 or position information measured by the movement detection unit 164 may be used instead of a password or a PIN. According to this configuration, a determination result or a measurement result in the movement detection unit 164 can be used as a code for unlocking in the BIOS or the UEFI, and a function restriction on the HMD 100 can be realized by using the lock function of the BIOS or the UEFI.

There may be a configuration in which, in the same manner as a remote lock function known in a smart phone or a tablet computer, the function can be locked through communication with the HMD 100 from a remote location. In this case, a position of the HMD 100 may be specified by a layout map in which a position thereof is correlated with the facility inside, an ID for specifying a building, an address indicating a residence, a zip code, a postal code, and a working place. There may be a configuration in which the remote lock function is valid in the HMD 100 at all times, and a determination result in the movement detection unit 164 or position information measured by the movement detection unit 164 is used as a password or a PIN for unlocking. In this case, it is possible to realize a function restriction on the HMD 100 by using the remote lock function.

A function restriction performed by the CPU 140 is not limited to the examples shown in steps S18 to S21. For example, the CPU 140 may restrict the display function of the right display drive unit 22 and the left display drive unit 24. In other words, the CPU 140 may perform a restriction on drawing on the right LCD 241 and the left LCD 242, a function restriction on the right LCD control unit 211 and the left LCD control unit 212, and the like. Specifically, display such as blue back display (entire display in blue) or red back display (entire display in red) may be performed in a display region of the HMD 100, and thus the visibility of external scenery transmitted through the right light guide plate 261 and the left light guide plate 262 may be reduced (hindered). In this case, the extent of reduction (hindrance) of the visibility of external scenery may be the extent that the external scenery is recognizable but the user is given displeasure or discomfort. Such blue back display or red back display may be referred to as external scenery viewing hindrance display.

Warning display or notification display for performing a notification of being deviated from an available position or being out of an available range may be performed along with the external scenery viewing hindrance display. The warning display or the notification display may be performed according to any specific aspect, and may be performed by using text or an image. The warning display or the notification display may include information indicating that the external scenery viewing hindrance display is performed for the above reason, and a method for canceling the external scenery viewing hindrance display may also be displayed. For example, the method may include display of a contact address or a contact method such as a telephone number, a mail address, an account of SNS, and an address. The warning display or the notification display such as the external scenery viewing hindrance display is not limited to a case where a position of the HMD 100 is deviated from an available position or comes out of an available range, and may be performed in a case where the HMD 100 comes close to a position deviated from the available position or a position close to the outside of the available range, and, in this case, the warning display or the notification display may be performed without the external scenery viewing hindrance display.

FIG. 7 illustrates a process of restricting a predetermined function according to a position of the HMD 100 during operation of the HMD 100.

The CPU 140 performs the process illustrated in FIG. 7 in a preset cycle or at any time during operation of the HMD 100, and determines the presence or absence of a trigger for position checking (step S31). The trigger for position checking is, for example, that a set time has elapsed, or an instruction for position checking is given by an operation on the touch pad 14. The trigger for position checking may be that input operations of a preset number or larger detected by the input information acquisition unit 110 are performed, or movement of the HMD 100 of a set distance or more is measured by the GPS module 134. The trigger for position checking may be that an operation exceeding a set operation amount is measured by the nine-axis sensor 66.

In a case where it is determined that the trigger for position checking is not established (NO in step S31), the CPU 140 finishes the present process.

In a case where it is determined that the trigger for position checking is established (YES in step S31), the CPU 140 performs the process in step S13 (FIG. 6) so as to acquire a position of the HMD 100. Next, the CPU 140 performs the processes in steps S14 and S15.

In a case where the position of the HMD 100 corresponds to the position set in the social control data 120d or is included in the set range (YES in step S15), the CPU 140 finishes the present process.

In a case where the position of the HMD 100 does not correspond to the position set in the social control data 120d and is not included in the set range (NO in step S15), the CPU 140 performs a process of restricting a predetermined function of the HMD 100.

Here, the CPU 140 determines whether or not a process regarding a restriction target set in the social control data 120d is being performed (step S32). Specifically, it is determined whether or not an application processing data set as a deletion or lock target in the social control data 120d, or an application and a library set as a lock target is being executed.

In a case where the corresponding process is being executed (YES in step S32), the CPU 140 stops the corresponding process (step S33), and proceeds to step S18. In a case where the corresponding process is not being executed (NO in step S32), the CPU 140 proceeds to step S18. The CPU 140 performs the operations in steps S18 to S22 as described with reference to FIG. 6.

In the above description, for better understanding, an example has been described in which the presence or absence of the trigger for position checking is determined according to flow control, but a specific aspect of the invention is not limited thereto. For example, in a case where the CPU 140 detects that the trigger for position checking is established, the processes in step S13 and the subsequent steps in FIG. 7 may be performed according to interrupt control.

As a condition of performing the processes in steps S18 to S21, the CPU 140 may combine a position of the HMD 100 with other conditions. For example, in a case where it is determined that the position of the HMD 100 does not correspond to the position set in the social control data 120d and is not included in the set range, and another condition is established, the CPU 140 may perform the processes in steps S18 to S21. As another condition, for example, authentication based on information regarding a living body of the user may be performed. Specifically, authentication may be performed by imaging the face of the user with the external scenery imaging camera 61, or by detecting a fingerprint, a palm print, the iris, or the like with the HMD 100. In this case, there may be a configuration in which, in a case where the authentication is successful, the processes in steps S18 to S21 are not performed, and, in a case where the authentication fails, the processes in steps S18 to S21 are performed.

The HMD 100 according to the embodiment to which the invention is applied is the HMD 100 mounted on the head of a user, and includes the image display section 20 displaying an image and the CPU 140 performing processes including data processing. The HMD 100 includes the storage unit 120 which stores data processed by the CPU 140, and the movement detection unit 164 which detects that a position of the HMD 100 is not a set position. The HMD 100 includes the process control unit 166 restricts processing of data correlated with a set location among pieces of data stored in the storage unit 120 in a case where the movement detection unit 164 detects that a position of the HMD 100 is not a set position.

According to the HMD 100 to which the head mounted display and the control method for the head mounted display are applied in the invention, it is possible to restrict data processing performed in the HMD 100 in a case where the HMD 100 is moved from a set position to another position. Thus, it is possible to achieve an effect of restricting movement of the HMD 100 to an unexpected location. Therefore, whether or not the HMD 100 is available can be controlled in relation to a location of use, and, thus, for example, it is possible to expect an effect of suppressing carrying-away of the HMD 100 or the illegal use of data.

The HMD 100 includes the external scenery imaging camera 61 imaging external scenery. The movement detection unit 164 detects that a position of the HMD 100 is not a set position on the basis of a captured image obtained by the external scenery imaging camera 61. Consequently, it is possible to control the use of the HMD 100 by using a captured image of external scenery which is an external real space of the HMD 100, or security information correlated with a location.

The HMD 100 detects that a position of the HMD 100 is not a set position on the basis of a beacon signal received by the wireless communication unit 132. The beacon signal in this case can be said to be security information correlated with a location set as a location of the use of the HMD 100. Consequently, it is possible to control the use of the HMD 100 by using a captured image of external scenery which is an external real space of the HMD 100 or security information correlated with a location.

The movement detection unit 164 may detect that a position of the HMD 100 is not a set position on the basis of a captured image obtained by the external scenery imaging camera 61 or security information correlated with a location. In this case, it is possible to control the use of the HMD 100 by using a captured image of external scenery which is an external real space of the HMD 100 or security information correlated with a location.

The storage unit 120 stores data including an application program, and the CPU 140 executes the application program so as to execute the functions of the HMD 100. The process control unit 166 restricts execution of an application program correlated with a set location. Consequently, it is possible to control execution of the application program for realizing the functions of the HMD 100 on the basis of a position of the HMD 100. Therefore, it is possible to appropriately control the use of the HMD 100 having various functions. The functions of the HMD 100 can be finely controlled, for example, by limiting a restriction target application program in order to restrict execution in the unit of the application program.

The process control unit 166 causes the movement detection unit 164 to perform detection as illustrated in FIG. 6 in a case where the HMD 100 is activated in a stoppage state or a power-off state. In a case where the movement detection unit 164 detects that a position of the HMD 100 is not a set position, access to data which is stored in the storage unit 120 and is correlated with a set location is restricted. Consequently, it is possible to restrict the use of the HMD 100 at an inappropriate location, for example, in a case where the HMD 100 is moved from a set location while the HMD 100 is in a stoppage state or a power-off state. Thus, it is possible to expect an effect of further suppressing movement of the HMD 100 to an unexpected location.

In a case where the movement detection unit 164 detects that a position of the HMD 100 is not a set position when the HMD 100 is activated in a stoppage state or a power-off state, the process control unit 166 erases data which is stored in the storage unit 120 and is correlated with a set location. Consequently, it is possible to restrict the use of data of the HMD 100, for example, in a case where the HMD 100 is moved from a set location while the HMD 100 is in a stoppage state or a power-off state. Thus, it is possible to reliably restrict the use of data at an unexpected location and thus to expect an effect of preventing the improper use of data.

The HMD 100 may detect that a use state of the HMD 100 is not a set use state. For example, a use state of the HMD 100 may be detected by a sensor such as the nine-axis sensor 66 of the HMD 100. A condition for determining a use state of the HMD 100 may be set in the social control data 120d.

In this case, the process control unit 166 may perform a restriction through the processes in steps S18 to S21 in a case where a use state of the HMD 100 does not correspond to the condition set in the social control data 120d. Consequently, it is possible to restrict the use of data on the basis of a use state of the HMD 100 and thus to expect an effect of preventing the improper use of the data.

By restricting the functions of the HMD 100, it is possible to restrict the use of, for example, document data, data of a table computation application program, presentation data, data of a webpage, and map data used by the business application 512. In a case where the HMD 100 supports work, the use of data such as a work procedure manual can be restricted. For example, in a case where the HMD 100 is connected to a wireless communication network and is used, connection to the network can be restricted through a function restriction. A restriction on a function or data is performed, and thus security of data can be held, so that the improper use of the HMD 100 can be prevented.

An available position or an available range (area) of the HMD 100 is not limited to a specific position or range specified by a GPS coordinate. For example, an available position or an available range of the HMD 100 may be specified according to methods other than a coordinate. For example, a company's office may be an available range. The entire building, one or a plurality of floors in a building, a part not partitioned in a building, one room partitioned in a building, a theater, a stadium, a site of a park, and administrative divisions such as prefectures and states may be an available range.

An available range of the HMD 100 may be specified by a road lane. In this case, the movement detection unit 164 specifies a lane on which a vehicle of a user wearing the HMD 100 is traveling on a road (an ordinary road or a highway). The movement detection unit 164 detects a case where a position of the vehicle is a passing lane, a case where a position of the vehicle is a traveling lane, and a case where a position of the vehicle is a resting place such as a service area or a road station. In this case, an available range of the HMD 100 may be set to a passing lane, a traveling lane, or a resting place. For example, a television watching function of the HMD 100 may be made valid in a resting place, and the function may be restricted in a traveling lane or a passing lane. Such a function may be applied in a case where the HMD 100 performs communication with a control device executing a vehicle driving assistance function (including so-called self-driving), or the HMD 100 has a driving assistance function. For example, in a case where the HMD 100 performs display related to the driving assistance function, with respect to a display function, for example, a process of restricting the display function may be performed according to a position of the vehicle. As another example, there may be an aspect in which a parking lot is divided into a parking space and a passage, and the parking space is set as an available range.

A description has been made of a case where the movement detection unit 164 detects movement of the HMD 100, but it can be said that the movement detection unit 164 detects that the HMD 100 is transferred, the HMD 100 is moved out of a predetermined region or section, and the HMD 100 is moved out of an area.

### B. Application Examples of HMD

Next, a description will be made of specific application examples using the HMD 100.

### B-1. Application Example 1

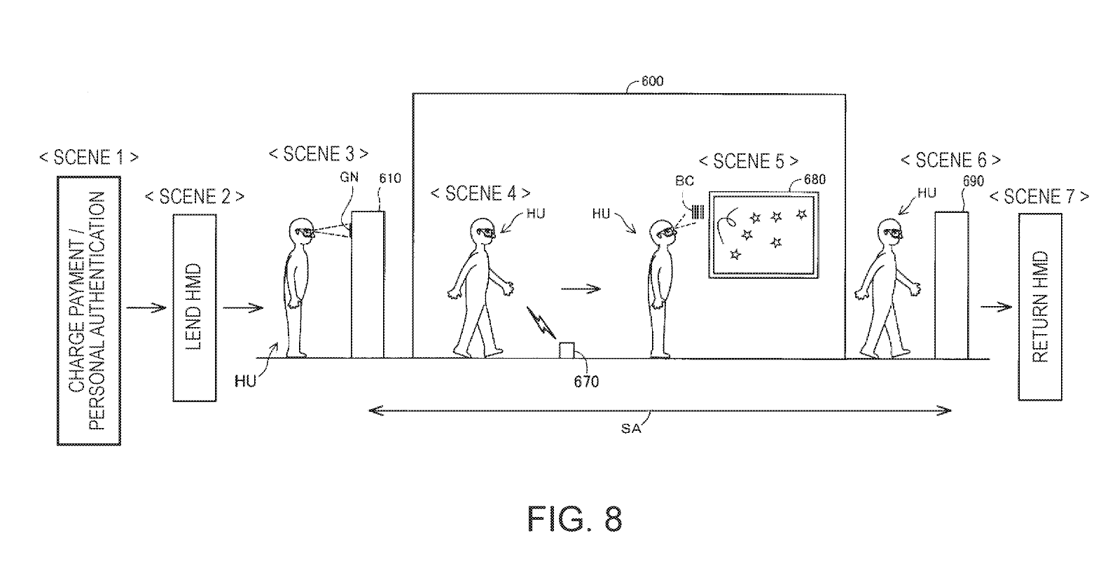

FIG. 8 is a diagram illustrating an application example using the functions of the HMD 100 and an application example in which a person visiting an art museum wears the HMD 100 and is guided in the art museum. Application Example 1 is also applicable to various exhibition facilities including museums, temporary exhibition as an event, and amusement facilities in addition to the art museum.

First, a person who visits the art museum goes to a reception desk and pays the entrance fee (scene 1). At this time, a receptionist may perform personal authentication of the visitor. The personal authentication is performed by receiving, for example, an identification card such as a license, a passport, or a health insurance card.

In a scene 2 following the scene 1, the receptionist lends the above-described HMD 100 to the visitor having completed the reception. In the lending, the receptionist inserts a hard key such as an IC card, a USB memory, or a SIM into the HMD 100. Instead of the hard key, a soft key such as a product key of the OS 150 may be input.

In a case where personal authentication is performed, a number or the like of the identification card may be input as a soft key. The soft key is input by using the input information acquisition unit 110 such as the touch pad 14 or the cross key 16. The hard key or the soft key which is input in the above-described way is stored in the storage unit 120 of the HMD 100 as an HMD authentication key. The receptionist lends the HMD 100 to which the hard key or the soft key is input to the visitor.

In a scene 3 following the scene 2, the visitor mounts the lent HMD 100 on the head thereof and uses the HMD 100. The visitor using the HMD 100 will be hereinafter referred to as a “user”. A gate (entrance) 610 is provided in front of an exhibition area 600 of the art museum, and, in the scene 3, a user HU advances to the front side of the gate 610. A gate identification name GN as a marker for identifying the gate 610 is written on the gate 610. In the scene 3, the user HU opens the gate 610 by using the functions of the HMD 100 including imaging of the gate identification name GN. This function will be described later in detail.

The user HU passes through the opened gate 610, and enters the exhibition area 600. A plurality of BLE terminals 670 for iBeacon are provided in the exhibition area 600. In a scene 4 in which the user HU is moving in the exhibition area 600, the user HU is presented with a route (guidance route) by using the functions of the HMD 100 including communication with the BLE terminal 670.

The user HU proceeds to the front of an exhibit 680 and appreciates the exhibit 680 (scene 5). A marker for identifying the exhibit 680 is provided on the periphery of the exhibit 680 in the form of a barcode BC. During appreciation, the user is presented with information regarding the exhibit 680 in front of the eyes by using the functions of the HMD 100 including imaging of the barcode BC. Details of this function will also be described later. The exhibit may be a display article.

The user HU having completed appreciation of exhibits moves from a gate (exit) 690 to the outside of the exhibition area 600 (scene 6), and returns the HMD 100 to the reception desk (scene 7).

In Application Example 1, the HMD 100 is activated in the scene 2, and images the authentication identification image GN such as a two-dimensional code provided on the gate 610 with the external scenery imaging camera 61. The identification image GN may be a character string.

The CPU 140 determines that a position of the HMD 100 is a set use position on the basis of the face that the identification image GN is detected in a captured image obtained by the external scenery imaging camera 61 (YES in step S15 in FIG. 6). Consequently, the functions of the HMD 100 can be used, and thus the guidance application 513 (FIG. 4) can be used.

In the scene 3, the CPU 140 may lock the sound processing unit frame 523 and the camera application 511 included in the application layer 510. Since the sound processing unit frame 523 outputs sounds from the HMD 100, the sound processing unit frame 523 is locked, and thus output of sounds from the HMD 100 is removed (mute). If the camera application 511 is locked, imaging using the camera application 511 is prohibited, and thus imaging of the exhibit 680 in the exhibition area 600 can be restricted. In a case where the HMD 100 is mounted with a camera other than the external scenery imaging camera 61, the camera application 511 may perform imaging using another camera. In this case, there may be a configuration in which the camera application 511 is locked, and thus imaging using another camera is prohibited.

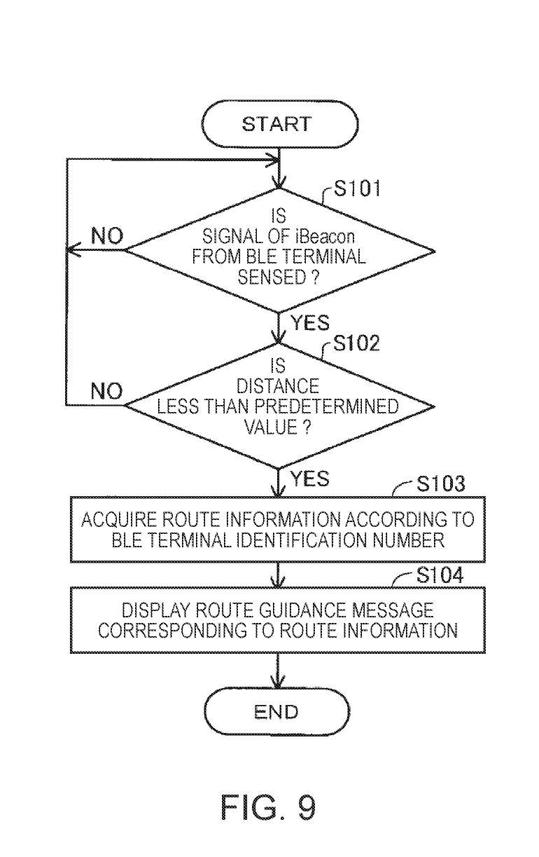

FIG. 9 is a flowchart illustrating details of a route guidance process routine.

The route guidance process routine is one of a plurality of process routines included in the appreciation support application 514 (FIG. 4), and is repeatedly executed every predetermined time by the CPU 140 of the HMD 100. In the route guidance process routine, the communication processing unit 172 is used. The BLE terminal 670 is disposed at each corner of the route, or an intermediate portion (hereinafter, referred to as a “linear intermediate portion”) in a case where a straight portion continues in the exhibition area 600, and a signal of iBeacon is output from the BLE terminal 670. The signal of iBeacon holds at least a BLE terminal identification number for identifying the BLE terminal 670 and a distance to the BLE terminal 670.

If the process is started, first, the CPU 140 of the HMD 100 determines whether or not a signal of iBeacon from the BLE terminal 670 is sensed (step S101). The CPU 140 repeatedly performs the process in step S101 until a signal of iBeacon is sensed, and determines whether or not the distance held in the sensed signal is less than a predetermined value (for example, 2 m) (step S102) in a case where it is determined that the signal is sensed in step S101. Here, in a case where it is determined that the distance is not less than the predetermined value, the process is returned to step S101.

On the other hand, in a case where it is determined that the distance is less than the predetermined value in step S102, a process of acquiring route information corresponding to the BLE terminal identification number held in the sensed signal is performed (step S103). The route information may be acquired, for example, by accessing a server apparatus (not illustrated) via a communication device (a wireless LAN device or the like), not illustrated, provided in the exhibition area 600. Route information corresponding to the BLE terminal 670 may be included in the content data 120e so as to be stored in the HMD 100. In this case, the CPU 140 acquires the route information corresponding to the signal sensed in step S101 from the content data 120e. The route information corresponds to a BLE terminal identification number, and is information such as the content that “turn to the left”, “turn to the right”, or “go straight”.

Next, the CPU 140 displays a route guidance message corresponding to the route information acquired in step S103 (step S104). In other words, the CPU 140 displays the route guidance message on the image display section 20.

After step S104 is executed, the CPU 140 temporarily finishes the route guidance process routine in FIG. 9. The processes in steps S101 and S102 performed by the CPU 140 correspond to the movement detection unit 164 (FIG. 2). In other words, the movement detection unit 164 detects that the HMD 100 is moved to the vicinity of the corner of the route or the vicinity of the linear intermediate portion as a specific location. The processes in steps S103 and S104 executed by the CPU 140 correspond to the process control unit 166 (FIG. 2). In other words, the process control unit 166 extends the information presenting function so as to display the route guidance message.

As mentioned above, the HMD 100 executes the route guidance process routine in the exhibition area 600, and thus the user wearing the HMD 100 can recognize the route guidance message in a visual field thereof when moving inside the exhibition area 600. Thus, according to the HMD 100 of the present embodiment, a user's convenience is favorable.

In the process according to the route guidance process routine, movement of the HMD 100 worn by a user is detected by using the iBeacon technique. The invention is not limited thereto, and movement of the HMD may be detected by predicting the current position by using position information which is registered when an access point of WiFi is provided. Movement of the HMD may be detected through visible light communication using an LED. To summarize, any wireless communication technique may be used as long as movement of the HMD is detected on the basis of a signal from an external wireless communication terminal. Movement of the HMD may be detected according to a technique of obtaining the indoor current position by using geomagnetism or an indoor GPS technique. In a case where the exhibition area 600 is located outdoors, movement of the HMD may be detected by specifying the current position by using the GPS module 134. Instead of a configuration of detecting movement of the HMD by using one of the techniques, movement of the HMD may be detected by combining a plurality of techniques among the techniques. The techniques may be used depending on a detection location or the like.

The appreciation support application 514 may explain an exhibit in the scene 5.

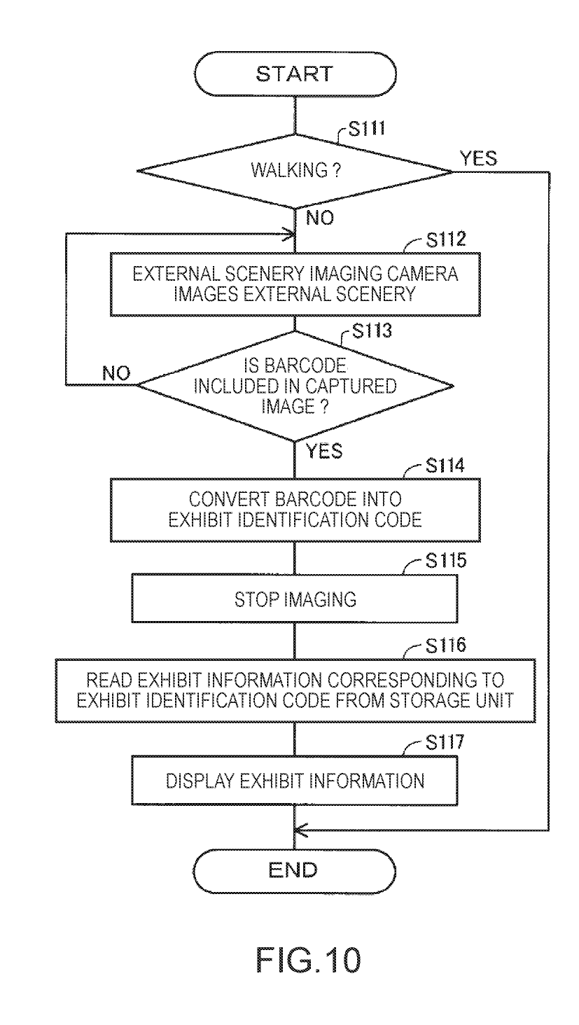

FIG. 10 is a flowchart illustrating details of an exhibit explanation routine. The exhibit explanation routine is one of a plurality of process routines included in the appreciation support application 514 (FIG. 4), and is repeatedly executed every predetermined time by the CPU 140 of the HMD 100. If the process is started, first, the CPU 140 detects motion of the head of the user with the nine-axis sensor 66 so as to determine whether or not the user is walking (step S111). Here, in a case where it is determined that the user is walking, the user is in a state of not appreciating an exhibit, and the exhibit explanation routine is temporarily finished.

On the other hand, in a case where it is determined that the user is not walking in step S111 (NO in step S111), the external scenery imaging camera 61 is activated to image external scenery (step S112). As a modification example, imaging of external scenery may be directly performed in step S112 without performing determination in step S111.

Next, the CPU 140 determines whether or not the barcode BC for exhibit identification is included in the captured image obtained in step S112 (step S113). Here, in a case where it is determined that the barcode BC for exhibit identification is not included, the CPU 140 returns the process to step S112, and continuously causes the external scenery imaging camera 61 to perform imaging, and waits for the barcode BC to be imaged. On the other hand, in a case where it is determined that the barcode BC for exhibit identification is included in step S113, the CPU 140 converts the barcode BC into an identification code of the exhibit 680 (step S114), and stops imaging in the external scenery imaging camera 61 (step S115). Thereafter, the CPU 140 reads exhibit information corresponding to the exhibit identification code obtained in step S114 from an exhaust information storage unit 654e (step S116), and displays the exhibit information (step S117). In other words, the CPU 140 displays the exhibit information on the image display section 20. The exhibit information is displayed at a position based on the position of the barcode BC included in the external scenery. The exhibit information may include text, images, graphics, moving images, and the like, and such data is included in the content data 120e. The content data 120e may include the exhibit information in correlation with an exhaust identification code. In the present embodiment, as illustrated in FIG. 8, the barcode BC is laid on the upper left part of the exhibit 680, and the exhibit information is displayed at the position in the leftward direction of the barcode BC, but any positions thereof may be employed.

After step S117 is executed, the CPU 140 temporarily finishes the exhibit explanation routine. The processes in steps S112 and S113 performed by the CPU 140 correspond to the movement detection unit 164 (FIG. 2). In other words, the movement detection unit 164 detects that the HMD 100 is moved to the front of the exhibit 680 as a specific location. The processes in steps S116 and S117 executed by the CPU 140 correspond to the process control unit 166 (FIG. 2). In other words, the process control unit 166 extends the information presenting function so as to display the exhibit information.

According to the exhibit explanation routine, a user wearing the HMD 100 has only to stand in front of the exhibit 680 and can thus recognize exhibition information such as information regarding the technique of the exhibit 680, the historical background, and the art history in a visual field thereof. Thus, according to the HMD 100 of the present embodiment, a user's convenience is favorable.

In the process according to the exhibit explanation routine, it is detected that the HMD 100 worn by the user is moved to the front of the exhibit by imaging the barcode BC attached to the periphery of the exhibit 680. The invention is not limited thereto, and the barcode BC may be a simple clear black-and-white graphic or other types of codes such as QR Code (registered trademark). Instead of the configuration in which the barcode BC is laid on the upper left part of the exhibit 680, the barcode BC may be disposed at any position on the periphery of the exhibit 680. A code may be disposed inside the exhibit 680 in the form of digital watermark. There may be a configuration in which it is detected that the HMD is moved to the front of the exhibit 680 on the basis of a captured image of the exhibit.

In this application example, in a case where a position of the HMD 100 is not the exhibition area 600 (between the gate 610 and the gate 690) which is an available range, access to exhibit information or route information is prohibited, and thus it is possible to prevent the improper use of such information. If such information is deleted, it is possible to more reliably prevent the improper use of the information. For example, data of the gate identification name GN or the barcode BC used in the exhibition area 600, the exhibit information or the route information, and data of a captured image obtained in the facility may be deleted outside the exhibition area 600. Data stored in the storage unit 120 of the HMD 100 as an HMD authentication key, and data such as charging history or payment history (for example, electronic signature, retinal authentication, pulse wave authentication) may be deleted outside the exhibition area 600.

As in this application example, the HMD 100 can cope with a business model in which the HMD 100 is lent in a specific location such as an art museum or a theater. As described above, if the HMD enters a specific location, the camera application 511 cannot be used, and authentication of a marker (the gate identification name GN or the barcode BC) using the external scenery imaging camera 61 becomes valid. Consequently, an image of an individual cannot be captured, the privacy problem is solved, and the copyright of an exhibit can be protected.

### B-2. Application Example 2

As Application Example 2, there may be an example in which the HMD 100 is used for sightseeing guidance in a sightseeing place.

For example, an example is assumed in which the guidance application 513 displays information regarding a sightseeing spot through display of a text message or image display in a state in which a user wearing the HMD 100 is walking in a sightseeing place. The display may be performed by using an AR technique. The displayed information may be guidance of the building history, an era picture, or display of an era reproduction video. Such information may be included in the content data 120e. In a case where the HMD 100 is located outside the sightseeing place set as an available range, such information the content data 120e may be deleted, or access thereto may be restricted. The content data 120e including such information may be downloaded to the HMD 100 from the outside at the time of starting sightseeing guidance, and the content data 120e may be deleted in a case where the HMD 100 comes out of an available range. Execution of the guidance application 513 may be restricted.

### B-3. Application Example 3

As Application Example 3, there may be an example in which the HMD 100 is used to support appreciation in a stadium, a movie theater, or a theater. For example, in a case where a user wearing the HMD 100 is located on an upper floor of a stadium, the appreciation support application 514 may display a captured image obtained through zoom imaging in the external scenery imaging camera 61 of the HMD 100. In this example, display with a live feeling can be performed such that an image of a player or an image of a performer is seen to be enlarged. In a case where the user sits on a seat close to a field of a stadium or a stage of a theater, the appreciation support application 514 may acquire a captured image obtained by an external camera via the wireless communication unit 132, and may display the captured image to be enlarged.

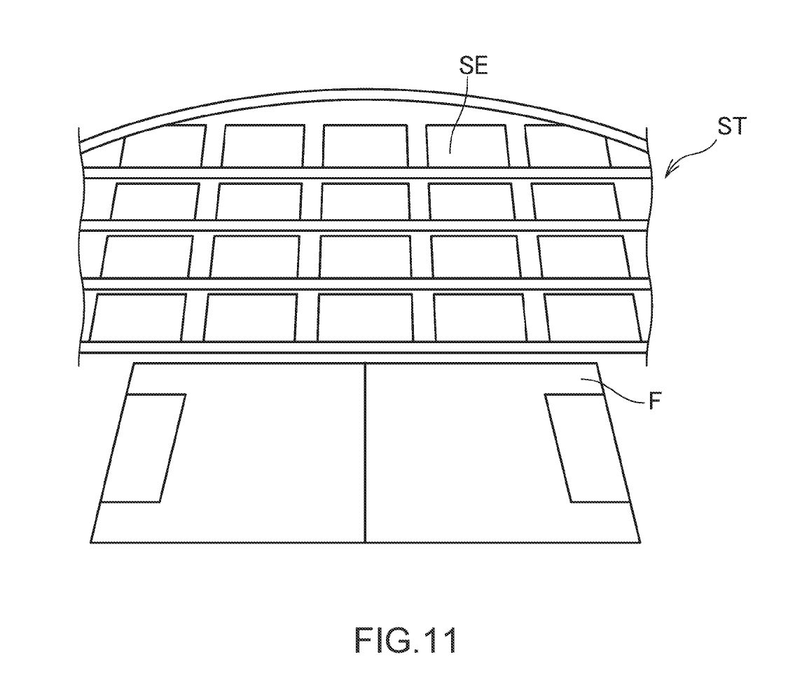

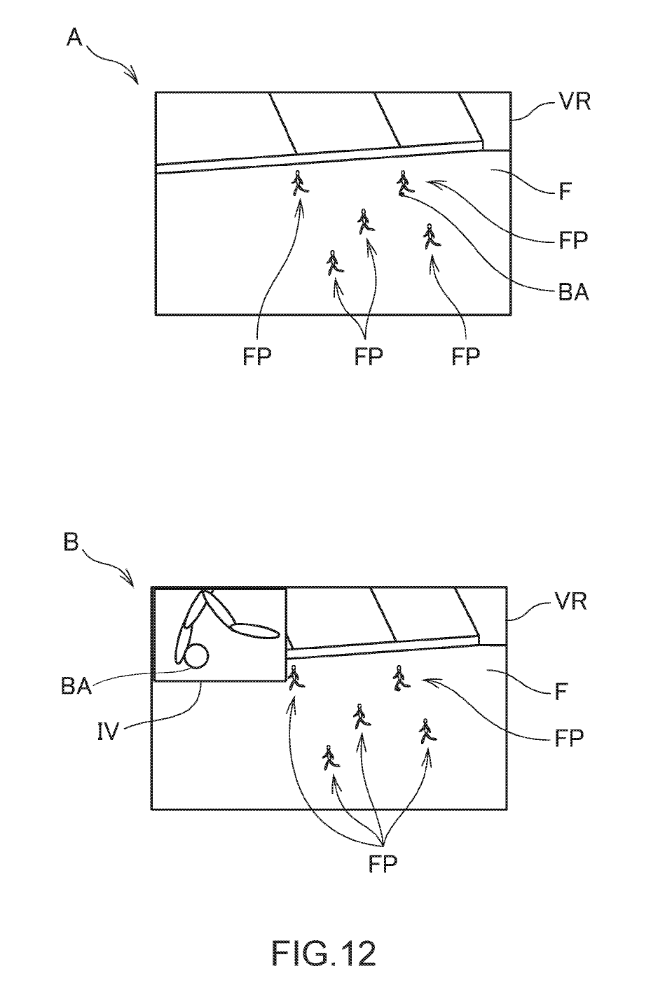

FIGS. 11 and 12 are diagrams illustrating a use state in Application Example 3, and FIG. 11 is a diagram illustrating a specific example of a use location of the HMD 100 in Application Example 3. FIG. 12 is a diagram illustrating a specific display aspect of the HMD 100 in Application Example 3.

FIG. 11 illustrates an example in which a user wears and uses the HMD 100 in a stadium ST having spectacle stands SE of multiple stories (four stories in FIG. 11). In this example, in a case where the user is located on an upper floor such as a fourth floor or a third floor, a distance to a field F is long, and thus it is not easy to visually recognize details of players in the field F or a game.

In FIG. 12, the reference sign A indicates an example of external scenery visually recognized through the HMD 100 in the use state illustrated in FIG. 11, and the reference sign B indicates an example of display performed by the HMD 100.

As indicated by the reference sign A, the user visually recognizes players FP on the field F and a ball BA used in the game, through the HMD 100. Here, as indicated by the reference sign B, the HMD 100 displays an enlarged image IV in which the vicinity of the ball BA is enlarged in a display region with the function of the appreciation support application 514. The appreciation support application 514 determines that the user visually recognizes the field F while looking downward on the basis of a visual line direction of the user or an attitude of the HMD 100, and disposes the enlarged image IV not to block the visual line on an upper part in the display region.

Consequently, the user can view the players FP without being hindered by the enlarged image IV in a visual field VR, and can view the vicinity of the ball used in the game with the enlarged image IV. The enlarged image IV may be generated from an image captured by the external scenery imaging camera 61. Alternatively, as described above, the enlarged image IV may be an image which is captured by an external camera and is acquired by the appreciation support application 514 via the wireless communication unit 132.

In Application Example 3, in a case where a position of the HMD 100 is outside a stadium, a movie theater, or a theater set as an available range, captured image data in the external scenery imaging camera 61 or a captured image downloaded by the HMD 100 may be erased. Execution of the appreciation support application 514 may be prohibited.

### B-4. Application Example 4

As Application Example 4, there may be an example in which the HMD 100 is used to provide information in a company, a school, a library, an amusement park, or the like. For example, a case is assumed in which an employee of a company is a user wearing the HMD 100. For example, in a case where a security area such as a company is set as an available range, a system is assumed in which the user can enter the company in a case where the user is authenticated by an authentication device at an entrance by using an ID card or an IC tag carried by the user. In this configuration, after authentication is successful, authentication information is transmitted to the HMD 100, the business application 512 including an application required for business can be used, and the HMD 100 can be connected to a communication network in the company. This may also be the same for an entering process in a school, a library, an amusement park, or the like. In Application Example 4, in a case where a position of the HMD 100 is a company, a school, a library, an amusement park, or the like set as an available range, captured image data in the external scenery imaging camera 61 or a captured image downloaded by the HMD 100 may be erased. Execution of the business application 512 may be prohibited.

### B-5. Application Example 5

As Application Example 5, there may be an example in which the HMD 100 is used to support appreciation in a movie theater, a theater, or the like. For example, there may be a case where, during the appreciation of a foreign language movie or play, the appreciation support application 514 performs display of translated subtitles, display of translation results of subtitles, output of dubbed voice to a native language, display of lyrics, display of explanations of lyrics, display of explanations on stories, and the like. There may be a configuration in which authentication is performed when a user enters a movie theater, a theater, or the like set as an available range, and, after authentication, activation of the appreciation support application 514 and/or access to the content data 120e including data used in the appreciation support application 514 becomes possible.

In Application Example 5, in a case where a position of the HMD 100 is not a movie theater, a theater, or the like set as an available range, activation of the appreciation support application 514 and/or access to the content data 120e including data used in the appreciation support application 514 can be prohibited.

### B-6. Application Example 6

As Application Example 6, there may be an example in which the HMD 100 is used for work support in an office (work place) such as a production line. The HMD 100 displays detailed procedures of work with the function of the business application 512. For example, in a case where maintenance work of a bicycle is performed, guidance including know how in work of detaching components, cleaning work, scratch inspection work, component attachment work, and the like is performed through display of images or text. Such information may be included in the content data 120e as, for example, a work procedure manual.

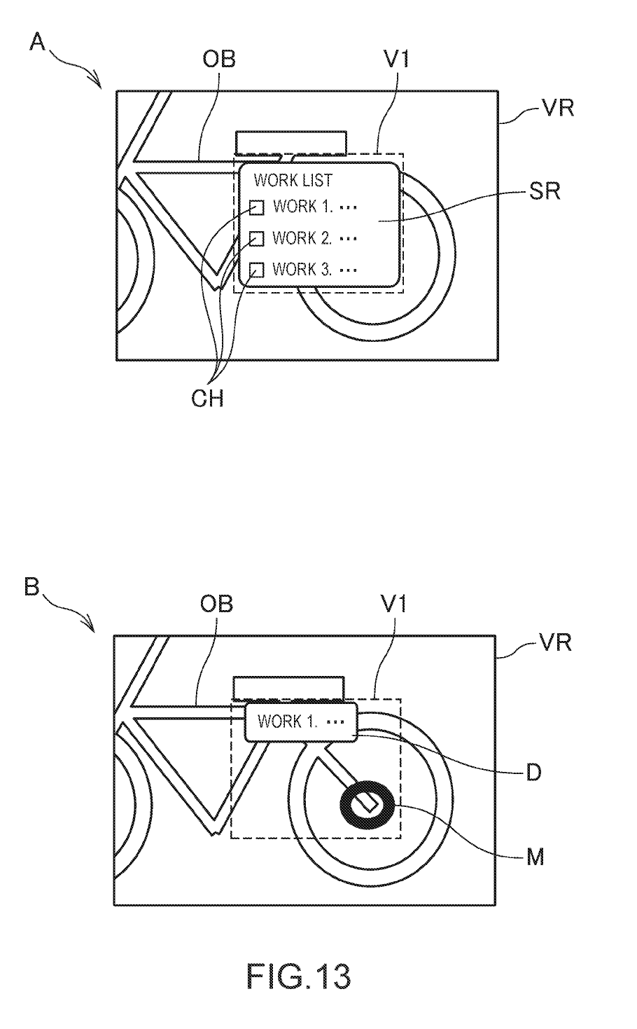

FIG. 13 is a diagram illustrating an example of a display aspect of the HMD 100 in Application Example 6. In FIG. 13, the reference sign A indicates an example in which the HMD 100 displays a work list, and the reference sign B indicates display of guidance of a work procedure.

In the example illustrated in FIG. 13, as indicated by the reference sign A, a list of pieces of work defined in the work procedure manual included in the content data 120e may be displayed in a display region V1 as a work list SR with the function of the business application 512. The work list SR is displayed to be superimposed on a work target object OB visually recognized through the HMD 100, and is used to guide work performed on the work target object OB. Checkboxes CH are displayed in the work list SR, and a check mark is displayed in the checkbox CH in finished work. Thus, a user can easily understand a work finish state of each item, and can thus recognize a work progress situation.

In the display state indicated by the reference sign B, an explanation D of the work content is displayed to be superimposed on the work target object OB on the background with the function of the business application 512, and the user can understand work performed on the work target object OB. In the example indicated by the reference sign B, work location display M indicating a work location in the work target object OB is performed to be superimposed on the work target object OB in an augmented reality (AR) manner. Thus, the user can also understand a work location in the work target object OB.

In Application Example 6, in a case where a position of the HMD 100 is not a work place set as an available range, the content data 120e including the work procedure manual is locked. Thus, the work procedure manual cannot be viewed. As described above, even if the HMD 100 is moved from a work place in a state in which the power source thereof is turned off, and the power source of the HMD 100 is turned on in another place, the work procedure manual cannot be viewed. Therefore, it is possible to prevent the improper use of the work procedure manual including know how.

In Application Example 6, a process of displaying work procedures is not limited to being performed by a dedicated application such as the business application 512, and may be performed by, for example, a function of a display application for displaying a general document file.

In Application Example 6, there may be a use aspect in which work procedures are taken over to another HMD 100 from the HMD 100 worn by the user. This function may be realized as, for example, the function of the business application 512. Specifically, data regarding the work execution history or work procedures is transmitted and received between two HMDs 100. Consequently, information regarding work of which execution is in progress can be taken over from one user to another user, and another user can continuously perform the work while receiving work support from the business application 512. In this configuration, in a case where one HMD 100 is moved to a place other than a work place set as an available range, data which is transmitted and received during taking-over may be deleted from one or both of the HMDs 100. The function may be restricted such that the HMD 100 moved to a place other than a work place cannot be connected to a network which enables communication with a plurality of HMDs 100 in the work place.

### B-7. Application Example 7

As Application Example 7, there may be an example in which the HMD 100 is worn by a user who is a patient, and is used for medical examination guidance in a hospital, waiting time display, guidance to an examination device or an examination room, and the like. In this example, it is assumed that the HMD 100 performs position measurement through route analysis using a captured image in the external scenery imaging camera 61, iBeacon, an optical beacon, short-range wireless communication, and the like, with the function of the guidance application 513, and performs path guidance corresponding to the measured position. This operation is the same as the operation illustrated in FIG. 9. Specifically, an examination place and a medical examination place may be guided from medical example reception according to a medical examination order. The HMD 100 may acquire movement information in conjunction with information such as a medical examination card or a medical record. In this case, a navigation function may be realized such that the user can automatically move to a medical examination section by interlocking a reception number with medical examination reception.

In Application Example 7, imaging in the external scenery imaging camera 61 may be prohibited in usage other than recognition of a marker based on a captured image in a location inside the hospital set as an available range. In a case where the HMD 100 is located in a location out of an available range, the function of the guidance application 513 may be stopped.

### B-8. Application Example 8

As Application Example 8, there may be an example in which a user wearing the HMD 100 rides a vehicle such as an automobile or a motorcycle. In this example, a vehicle driving location is set as a location where a function is restricted. In other words, a vehicle driving location (a location where a driving operation is performed, a driver's seat) is set as the outside of an available range. In this case, the HMD 100 recognizes whether or not the HMD is located in a driving location on the basis of a captured image obtained by the external scenery imaging camera 61. The HMD 100 may restrict the functions thereof in a case where a position of the HMD 100 is the driving location, and the user is driving on the basis of a captured image or the like. In this case, moving image watching and execution of browsing are restricted due to the function restriction. Regarding display of information in the HMD 100, the transmittance or a size of a display image may be controlled such that a display position or a display size is adjusted to avoid a state in which traffic signals, cars, and people are not viewed. For example, control may be performed such that the driven vehicle switches to self-driving in which operations except for braking for avoidance of danger are switched to automatic operation in a case where the driven vehicle enters a specific area (for example, a park or a restricted city area).

### B-9. Other Application Examples

As other application examples, a toilet, a priority seat in a train, a public space, a mountain, the sea, a foreign country, a workplace with a security restriction, a school, the inside of an airplane, or the like may be set as an available position or an available range. In this case, a configuration is considered in which the business application 512, the guidance application 513, or the appreciation support application 514 corresponding to an available position or an available range is executed to provide convenience to a user of the HMD 100. In this case, the HMD 100 can prevent the improper use of a function by restricting execution of the function according to a location of the HMD 100.

An application range, a position, and a function of the HMD 100 are not limited to each of the above-described application examples.

The invention is not limited to the configuration of the embodiment, and can be implemented in various aspects without departing from the sprit thereof.

For example, in the embodiment, a configuration in which a user visually recognizes external scenery through a display unit is not limited to a configuration in which external scenery is transmitted through the right light guide plate 261 and the left light guide plate 262. For example, the invention is applicable to a display apparatus which displays an image in a state in which external scenery cannot be visually recognized. Specifically, the invention is applicable to a display apparatus which displays a captured image obtained by the external scenery imaging camera 61, an image or CG generated on the basis of the captured image, videos based on video data stored in advance or video data which is externally input, and the like. This type of display apparatus may include a so-called closed type display apparatus in which external scenery cannot be visually recognized. As described in the embodiment, AR display in which an image is displayed to be superimposed on a real space, or mixed reality (MR) display in which a captured image of a real space is combined with a virtual image may be used. Alternatively, the invention is applicable to a display apparatus which does not perform a process such as virtual reality (VR) display in which a virtual image is displayed.

For example, a display apparatus which displays video data which is externally input or an analog video signal is also included in an application target of the invention.

For example, instead of the image display section 20, image display sections of other types, such as an image display section which is mounted like a cap, may be employed. The image display section may include a display unit displaying an image in accordance with the left eye of a user and a display unit displaying an image in accordance with the right eye of the user. For example, the display apparatus according to the invention may be configured as a head mounted display mounted on a vehicle such as an automobile or an airplane. For example, the display apparatus according to the invention may be configured as a head mounted display built into a body protecting instrument such as a helmet. In this case, a portion for positioning a position with respect to a user's body and a portion positioned with respect to the portion may be used as a mounting portion.

The control section 10 and the image display section 20 may be integrally configured and may be mounted on the head of a user. As the control section 10, portable electronic apparatuses including a notebook computer, a tablet computer, a game machine, a mobile phone, a smart phone, and a portable media player, or other dedicated apparatuses may be used.

In the embodiment, as an example, a description has been made of a configuration in which the image display section 20 and the control section 10 are separated from each other, and are connected to each other via the connection unit 40, but the control section 10 and the image display section 20 may be connected to each other via a wireless communication line.

There may be a configuration in which a virtual image is formed by a half mirror in parts of the right light guide plate 261 and the left light guide plate 262 as an optical system guiding image light to the eyes of a user. There may be a configuration in which an image is displayed in a display region having an area occupying the entire surface or the most part of the right light guide plate 261 and the left light guide plate 262. In this case, an operation of changing a display position of an image may include a process of reducing an image. A diffraction grating, a prism, and a holography display unit may be used.

At least some of the respective functional blocks illustrated in the block diagram may be realized in hardware, and may be realized in cooperation between hardware and software, and the invention is not limited to a configuration in which an independent hardware resource is disposed as illustrated. A program executed by the CPU 140 may be stored in the storage unit 120, and a program stored in an external device may be acquired and executed. A constituent element formed in the control section 10 may be also formed in the image display section 20. For example, a processor such as the CPU 140 may be disposed in the image display section 20, and the CPU 140 of the control section 10 and the processor of the image display section 20 may execute separate functions.

The entire disclosure of Japanese Patent Application No. 2017-115809, filed Jun. 13, 2017 is expressly incorporated by reference herein.

What is claimed is:

1. A head mounted display mounted on the head of a user, comprising:
a display unit that displays an image;
a processing unit that performs processes including processing on data;
a storage unit that stores the data processed by the processing unit;
a detection unit that detects that a position of the head mounted display is not a set position; and
a control unit that restricts processing on data correlated with the set position among pieces of the data stored in the storage unit in a case where the detection unit detects that a position of the head mounted display is not the set position.

2. The head mounted display according to claim 1, further comprising:
an external scenery imaging unit that images external scenery,
wherein the detection unit detects that a position of the head mounted display is not the set position on the basis of at least one of a captured image obtained by the external scenery imaging unit and security information correlated with the set position.

3. The head mounted display according to claim 2,
wherein, in a case where it is detected that a position of the head mounted display is not the set position on the basis of the captured image obtained by the external scenery imaging unit and the security information correlated with the set position, the control unit performs any of external scenery viewing hindrance display, warning display, notification display, and function lock, as a function restriction.

4. The head mounted display according to claim 1,
wherein the storage unit stores the data including an application program,
wherein the processing unit executes the application program so as to execute a function of the head mounted display, and
wherein the control unit restricts execution of the application program correlated with the set position.

5. The head mounted display according to claim 1,
wherein the control unit causes the detection unit to perform detection when the head mounted display is activated in a stoppage state or a power-off state, and
wherein, in a case where the detection unit detects that a position of the head mounted display is not the set position, the control unit restricts access to the data which is stored in the storage unit and is correlated with the set position.

6. The head mounted display according to claim 5,
wherein, in a case where the detection unit detects that a position of the head mounted display is not the set position when the head mounted display is activated in a stoppage state or a power-off state, the control unit erases the data which is stored in the storage unit and is correlated with the set position.

7. The head mounted display according to claim 1,
wherein the detection unit detects that a use state of the head mounted display is not a set use state, and
wherein, in a case where the detection unit detects that a use state of the head mounted display is not the set use state, the control unit restricts processing on data correlated with the set position among the pieces of data stored in the storage unit.

8. A control method for a head mounted display including a display unit that displays an image, a processing unit that performs processes including processing on data, and a storage unit that stores the data processed by the processing unit, the control method comprising:
restricting processing on data correlated with a set position among pieces of the data stored in the storage unit in a case where it is detected that a position of the head mounted display is not the set position.
